(19) United States
(12) Patent Application Publication
(10) Pub. No.: US 2026/0311307 A1
(43) Pub. Date: Oct. 8, 2026

(54) IMAGE PROCESSING METHODS AND APPARATUSES, ELECTRONIC DEVICES AND STORAGE MEDIA

(71) Applicant: BOE Technology Group Co., Ltd., Beijing (CN)

(72) Inventors: Yanhong WU, Beijing (CN); Yan GAO, Beijing (CN)

(21) Appl. No.: 18/996,882

(22) PCT Filed: Apr. 28, 2023
(86) PCT No.: PCT/CN2023/091640

§ 371 Date: Jan. 17, 2025

(51) Int. Cl. G06T 5/77; G06T 3/40; G06T 5/70; G06V 40/16

(52) U.S. Cl. CPC G06T 5/77; G06T 3/40; G06T 5/70; G06V 40/161

(57) ABSTRACT

The disclosure relates to an image processing method and apparatus, an electronic device and a storage medium. The method includes the following steps: identifying video image frames of a video stream to obtain an initial image including a face; aligning a face region in the initial image with the preset skin template to obtain a mapping relationship between the face region and the preset skin template, and adjusting the skin region of the face region to obtain an adjusted image; determining the skin region based on the mapping relationship; performing image quality enhancement processing on the adjusted image to obtain an enhanced image; and rendering the enhanced image to obtain a target image.

### TECHNICAL FIELD

The present disclosure relates image processing technical field, and in particular to image processing methods and apparatuses, electronic devices and storage media.

### BACKGROUND

As communication requirements increase, more and more users select online meetings for communication, such as video conferencing and voice conferencing. Taking a video conference as an example, an electronic device may collect a user image and upload the user image to a conference room, such that each user can see other users, achieving an effect similar to on-site conference.

However, in the related art, a user image is usually directly displayed, such that other users can see facial details of the user, for example, forehead wrinkles or freckles, thereby reducing user experience.

### SUMMARY

The present disclosure provides an image processing method and apparatus, an electronic device and a storage medium to solve the defects of related art.

According to a first aspect of embodiments of the disclosure, there is provided an image processing method, including:
identifying video image frames of a video stream to obtain an initial image including a face;
aligning a face region in the initial image with a preset skin template to obtain a mapping relationship between the face region and the preset skin template;
adjusting a skin region of the face region to obtain an adjusted image, where the skin region is determined based on the mapping relationship;
performing image quality enhancement processing on the adjusted image to obtain an enhanced image; and
rendering the enhanced image to obtain a target image.

In some embodiments, aligning the face region in the initial image with the preset skin template to obtain the mapping relationship between the face region and the preset skin template includes:
obtaining key point coordinates of a face in the preset skin template to obtain a first key point coordinate vector;
obtaining key point coordinates of the face in the initial image to obtain a second key point coordinate vector; and
inputting the first key point coordinate vector and the second key point coordinate vector into a preset distance model to obtain a solution of the preset distance model, and determining the solution of the preset distance model as the mapping relationship.

In some embodiments, obtaining the solution of the preset distance model includes:
respectively obtaining a coordinate mean value and a coordinate standard deviation of the first key point coordinate vector as a first coordinate mean value and a first coordinate standard deviation;
respectively obtaining a coordinate mean value and a coordinate standard deviation of the second key point coordinate vector as a second coordinate mean value and a second coordinate standard deviation;
subtracting the first coordinate mean value from the first key point coordinate vector and then dividing by the first coordinate standard deviation to obtain a first adjusted coordinate vector;
subtracting the second coordinate mean value from the second key point coordinate vector and then dividing by the second coordinate standard deviation to obtain a second adjusted coordinate vector; and
inputting the first adjusted coordinate vector and the second adjusted coordinate vector into the preset distance model, and performing singular value decomposition on the preset distance model to obtain the mapping relationship.

In some embodiments, adjusting the skin region of the face region to obtain the adjusted image includes:
in response to sequentially scaling the initial image with different preset size ratios to obtain candidate size images, performing clearing processing on one of the candidate size images to obtain a processed image; and
in response to a number of times of size adjustment being equal to a preset times threshold, restoring a size of a last processed image to a size of the initial image to obtain a first candidate image, and determining the first candidate image as the adjusted image.

In some embodiments, performing clearing processing on the candidate size image to obtain the processed image includes:
detecting at least one freckle region of a skin region of the candidate size image, where the freckle region is a connected component with an area within a first preset area range, a size less than a first preset size threshold and larger than a second preset size threshold;
performing clearing processing on the at least one freckle region to obtain a first processed image; and
in response to a first cycle condition being satisfied, restoring a size of the first processed image to a size of the initial image to obtain a final processed image;
where the first cycle condition is that a number of times of freckle region detection is equal to a first preset times threshold or a quantity of freckle regions currently detected is less than a first preset quantity threshold.

In some embodiments, detecting the at least one freckle region of the skin region of the candidate size image includes:
obtaining target pixel data based on the mapping relationship and pixel data of each pixel of the preset skin template;
replacing pixel data of corresponding positions in the candidate size image with the target pixel data to obtain a second candidate image; and
performing connected component detection on the skin region of the second candidate image to obtain the freckle region of the skin region, where the freckle region of the skin region is a connected component with a freckle region size less than a first preset size threshold and larger than a second preset size threshold in the skin region.

In some embodiments, performing connected component detection on the skin region of the second candidate image to obtain the freckle region of the skin region includes:
converting a grayscale image of the candidate size image to binary images based on respective preset thresholds to obtain frames of binary images;
respectively obtaining connected regions in the frames of binary images to obtain connected components in the frames of binary images;
classifying the connected components based on distances between center points of corresponding connected components in the frames of binary images, to obtain a plurality of connected components with distances between corresponding center points less than a preset distance threshold;
obtaining positions and sizes of the plurality of the connected components; and determining a connected component with a size less than the first preset size threshold and larger than the second preset size threshold of the plurality of the connected components as the freckle region of the skin region, where each position of the plurality of connected components refers to a mean value of center point coordinates of corresponding connected components in respective frames of binary images, and each size of the plurality of connected components refers to a radius length of a circumscribed circle with an area of the connected component of the binary image within a preset area range.

In some embodiments, after detecting the at least one freckle region of the skin region of the candidate size image, the method further includes:
in response to detecting no freckle region, determining whether there is a wrinkle region, where, the wrinkle region is a connected component having an area within a second preset area range, a size within a preset length range and a width within a preset width range;
in response to detecting at least one wrinkle region, performing clearing processing on a wrinkle region satisfying a second preset condition in the candidate size image to obtain a second processed image; and
in response to the second cycle condition being satisfied, restoring a size of the second processed image to the size of the initial image to obtain a final processed image;
where the second cycle condition is that a number of times of wrinkle region detection is equal to a second preset times threshold or a quantity of wrinkle regions currently detected is less than a second preset quantity threshold.

In some embodiments, performing clearing processing on the candidate size image to obtain the processed image includes:
detecting a wrinkle region of the skin region of the candidate size image, where the wrinkle region is a connected component having an area within a second preset area range, a size within a preset length range, and a width within a preset width range;
in response to detecting at least one wrinkle region, performing clearing processing on a wrinkle region satisfying a second preset condition in the candidate size image to obtain a third processed image; and
in response to the second cycle condition being satisfied, restoring a size of the third processed image to the size of the initial image to obtain the final processed image;
where the second cycle condition is that a number of times of wrinkle region detection is equal to a second preset times threshold or a quantity of wrinkle regions currently detected is less than a second preset quantity threshold.

In some embodiments, performing face adjustment processing on the face region in the initial image to obtain the adjusted image includes:
aligning the face region in the initial image with the preset skin template to obtain a mapping relationship between the face region and the preset skin template;
in response to sequentially scaling the initial image to candidate size images with different preset sizes, obtaining an abnormal region of the skin region in the candidate size image to obtain an abnormal region feature map, where the abnormal region includes a freckle region, a wrinkle region or both, the freckle region is a connected component with an area within a first preset area range, a size less than a first preset size threshold and larger than a second preset size threshold, the wrinkle region is a connected component with an area within a second preset area range, a size within a preset length range, and a width within a preset width range, and the second preset area range is larger than the first preset area range; and
in response to a number of times of size adjustment being equal to a preset times threshold, clearing the abnormal regions from a last candidate size image of the candidate size images to obtain the adjusted image.

In some embodiments, after obtaining the first candidate image, the method further includes:
scaling an eye region in the first candidate image to obtain a second candidate image, and determining the second candidate image as the adjusted image.

In some embodiments, scaling the eye region in the first candidate image to obtain the second candidate image includes:
obtaining a scaling ratio of each pixel in the eye region of the first candidate image;
obtaining target coordinate data of each pixel based on the scaling ratio and original coordinate data of each pixel; and
replacing original coordinate data of each pixel in the first candidate image with target coordinate data to obtain the second candidate image.

In some embodiments, obtaining the scaling ratio of each pixel in the eye region of the first candidate image includes:
obtaining a distance ratio of each pixel in the eye region of the first candidate image, where the distance ratio indicates that a distance ratio of a pixel closer to a center point of the eye region is smaller; and
obtaining the scaling ratio of each pixel based on the distance ratio, where the scaling ratio is proportional to the distance ratio.

In some embodiments, obtaining the distance ratio of each pixel in the eye region of the first candidate image includes:
obtaining a long axis length and a short axis length of the eye region; and
obtaining the distance ratio of each pixel based on the long axis length, the short axis length, the coordinate data of the center point of the eye region, and the original coordinate data of each pixel.

In some embodiments, obtaining the scaling ratio of each pixel based on the distance ratio includes:
obtaining the scaling ratio of each pixel based on the distance ratio and an initial value of the scaling ratio.

In some embodiments, after obtaining the second candidate image, the method further includes:
performing size adjustment on the face region in the second candidate image to obtain a third candidate image, and determining the third candidate image as the adjusted image.

In some embodiments, adjusting the size of the face region in the second candidate image to obtain the third candidate image includes:
obtaining a distance value between a control point C1 of the face region and each pixel in the face region;
obtaining a deformation ratio of each pixel based on the distance value, where the deformation ratio is configured to indicate that a moving distance of a pixel farther away from the control point C1 is smaller;
calculating target pixel data of each pixel based on coordinate data of a target position M of the control point C1, coordinate data of the control point C1, and coordinate data of a target position X of each pixel; and
replacing pixels of the face region of the second candidate image with the target pixel data to obtain the third candidate image.

In some embodiments, the image quality enhancement processing includes skin smoothing processing, whitening processing, brightening processing or any combination thereof, and performing image quality enhancement processing on the adjusted image to obtain the enhanced image includes:
performing skin smoothing processing on the adjusted image to obtain a first skin smoothed feature map;
adjusting a smoothing degree of the first skin smoothed feature map to obtain a second skin smoothed feature map;
performing skin tone brightening processing on the second skin smoothed feature map to obtain a skin tone brightened feature map;
performing soft light processing based on the skin tone brightened feature map and the adjusted image to obtain a soft light feature map; and
obtaining the enhanced image based on the adjusted image, the second skin smoothed feature map, the skin tone brightened feature map, the soft light feature map and respective weight values.

In some embodiments, performing skin smoothing processing on the adjusted image to obtain the first skin smoothed feature map includes:
performing filtering processing on a green sub-image of the adjusted image to obtain a filtered sub-image;
obtaining a pixel data difference value of a same pixel in the adjusted image and the filtered sub-image to obtain a difference sub-image;
compensating pixel data of each pixel in the difference sub-image based on preset compensation data to obtain a difference compensation sub-image; and
performing light compensation on the difference compensation sub-image to obtain the first skin smoothed feature map.

In some embodiments, a filtering method used for filtering the green sub-image of the adjusted image includes: averaging filtering, Gaussian filtering, bilateral filtering, guiding filtering, or any combination thereof.

In some embodiments, a filtering kernel of the Gaussian filtering is a circular filtering kernel, and a sum of weight values of the circular filtering kernel is equal to a preset weight value.

In some embodiments, performing light compensation on the difference compensation sub-image to obtain the first skin smoothed feature map includes:
comparing pixel data of each pixel of the difference compensation sub-image with preset compensation data;
in response to that the pixel data of each pixel is greater than or equal to the preset compensation data, obtaining target pixel data corresponding to the pixel data based on a first light compensation model;
in response to that the pixel data of each pixel is less than the preset compensation data, obtaining target pixel data corresponding to the pixel data based on a second light compensation model;
replacing pixel data of each pixel of the difference compensation sub-image with the target pixel data; and
in response to number of times of compensation reaching a preset compensation times threshold, determining that a difference compensation sub-image obtained by a last compensation is the first skin smoothed feature map.

In some embodiments, a value range of the preset compensation times threshold is [1, 10].

In some embodiments, adjusting the smoothing degree of the first skin smoothed feature map to obtain the second skin smoothed feature map includes:
obtaining a grayscale image corresponding to the adjusted image; and
performing brightening processing on grayscale data of each pixel in the grayscale image based on preset skin smoothing degree data to obtain a grayscale brightened image;
adjusting pixel data of each pixel of the adjusted image based on the first skin smoothed feature map and the grayscale brightened image to obtain the second skin smoothed feature map.

In some embodiments, after identifying the video image frames of the video stream, the method further includes:
performing, in response to no face region being detected in the video image frames, image quality enhancement processing on the video image frames to obtain the enhanced image; and
rendering the enhanced image to obtain the target image.

According to a second aspect of embodiments of the disclosure, there is provided an image processing apparatus, including:
an initial image obtaining module, configured to perform identification processing on video image frames of a video stream to obtain an initial image including a face;
a mapping relationship obtaining module, configured to align a face region in the initial image with a preset skin template to obtain a mapping relationship between the face region and the preset skin template;
an adjusted image obtaining module, configured to adjust a skin region of the face region to obtain an adjusted image, where the skin region is determined based on the mapping relationship;
an enhanced image obtaining module, configured to perform image quality enhancement processing on the adjusted image to obtain an enhanced image; and
a target image obtaining module, configured to perform rendering processing on the enhanced image to obtain a target image.

In some embodiments, the mapping relationship obtaining module includes:
a first vector obtaining submodule, configured to obtain key point coordinates of a face in the preset skin template to obtain a first key point coordinate vector;
a second vector obtaining submodule, configured to obtain key point coordinates of a face in the initial image to obtain a second key point coordinate vector; and
a mapping relationship obtaining submodule, configured to input the first key point coordinate vector and the second key point coordinate vector into a preset distance model, obtain a solution of the preset distance model, and use the solution of the preset distance model as the mapping relationship.

In some embodiments, the mapping relationship obtaining submodule includes:
a first vector processing unit, configured to respectively obtain a coordinate mean value and a coordinate standard deviation of the first key point coordinate vector as a first coordinate mean value and a first coordinate standard deviation;
a second vector processing unit, configured to respectively obtain a coordinate mean value and a coordinate standard deviation of the second key point coordinate vector as a second coordinate mean value and a second coordinate standard deviation;
a first vector adjusting unit, configured to subtract the first coordinate mean value from the first key point coordinate vector and then divide by the first coordinate standard deviation to obtain a first adjusted coordinate vector;
a second vector adjusting unit, configured to subtract the second coordinate mean value from the second key point coordinate vector and then divide by the second coordinate standard deviation to obtain a second adjusted coordinate vector; and
a mapping relationship obtaining unit, configured to input the first adjusted coordinate vector and the second adjusted coordinate vector into the preset distance model, and perform singular value decomposition on the preset distance model to obtain the mapping relationship.

In some embodiments, the adjusted image obtaining module includes:
a processed image obtaining submodule, configured to perform, in response to sequentially scaling the initial image with different preset size ratios to candidate size images, clearing processing on one of the candidate size images to obtain a processed image; and
a first candidate image obtaining submodule, configured to restore, in response to a number of times of size adjustment being equal to a preset times threshold, a size of a final processed image to a size of the initial image to obtain a first candidate image, and use the first candidate image as the adjusted image.

In some embodiments, the processed image obtaining submodule includes:
a freckle region detection unit, configured to detect at least one freckle region of a skin region of the candidate size image, where the freckle region is a connected component with an area within a first preset area range, a size less than a first preset size threshold and larger than a second preset size threshold;
a first processed image obtaining unit, configured to perform clearing processing on the at least one freckle region to obtain a first processed image; and
a processed image obtaining unit, configured to restore, in response to a first cycle condition being satisfied, a size of the first processed image to a size of the initial image to obtain a final processed image;
where the first cycle condition is that a number of times of freckle region detection is equal to a first preset times threshold or a quantity of freckle regions currently detected is less than a first preset quantity threshold.

In some embodiments, the freckle region detection unit includes:
a target pixel obtaining subunit, configured to obtain target pixel data based on the mapping relationship and pixel data of each pixel of the preset skin template;
a second candidate image obtaining subunit, configured to replace pixel data at a corresponding position in the candidate size image with the target pixel data to obtain a second candidate image; and
a freckle region obtaining subunit, configured to perform connected component detection on the skin region of the second candidate image to obtain the freckle region of the skin region, where the freckle region of the skin region is a connected component with a freckle region size less than a first preset size threshold and larger than a second preset size threshold in the skin region.

In some embodiments, the freckle region obtaining subunit includes:
a binary image obtaining subunit, configured to convert a grayscale image of the candidate size image to binary images based on respective preset thresholds to obtain frames of binary images;
a first connected component obtaining subunit, configured to obtain connected regions in frames of binary images to obtain connected components in the frames of binary images;
a second connected component obtaining subunit, configured to classify the connected components based on distances between center points of corresponding connected components in the frames of binary images to obtain a plurality of connected components with distances between corresponding center points less than a preset distance threshold;
a freckle region obtaining subunit, configured to obtain positions and sizes of the plurality of connected components, and determine a connected component with a size less than the first preset size threshold and larger than the second preset size threshold of the plurality of connected components as the freckle region of the skin region, where each position of the plurality of connected components refers to a mean value of center point coordinates of corresponding connected components in respective frames of binary images, and each size of the plurality of connected components refers to a radius length of a circumscribed circle when an area of the connected component of the binary image is within a preset area range.

In some embodiments, after detecting the at least one freckle region of the skin region of the candidate size image, the processed image obtaining submodule further includes:
a wrinkle region determining unit, configured to determine, in response to detecting no freckle region, whether there is a wrinkle region, where the wrinkle region is a connected component with an area within a second preset area range, a size within a preset length range, and a width within a preset width range;
a wrinkle region clearing unit, configured to clear, in response to detecting at least one wrinkle region, a wrinkle region satisfying a second preset condition in the candidate size image to obtain a second processed image; and
a processed image obtaining unit, configured to restore, in response to a second cycle condition being satisfied, a size of a second processed image to a size of the initial image to obtain a final processed image;
where the second cycle condition is that a number of times of wrinkle region detection is equal to a second preset times threshold or a quantity of wrinkle regions currently detected is less than a second preset quantity threshold.

In some embodiments, the processed image obtaining submodule includes:
a wrinkle region detection unit, configured to detect a wrinkle region of the skin region of the candidate size image, where the wrinkle region is a connected component with an area within a second preset area range, a size within a preset length range, and a width within a preset width range;
a third processed image obtaining unit, configured to clear, in response to detecting at least one wrinkle region, a wrinkle region satisfying a second preset condition in the candidate size image to obtain a third processed image; and
a processed image obtaining unit, configured to restore, in response to a second cycle condition being satisfied, a size of the third processed image to the size of the initial image to obtain a final processed image;
where the second cycle condition is that a number of times of wrinkle region detection is equal to a second preset times threshold or a quantity of wrinkle regions currently detected is less than a second preset quantity threshold.

In some embodiments, the adjusted image obtaining module includes:
a mapping relationship obtaining submodule, configured to align the face region in the initial image with a preset skin template to obtain a mapping relationship between the face region and the preset skin template;
abnormal regions obtaining submodule, configured to obtain, in response to sequentially scaling the initial image to candidate size images with different preset sizes, an abnormal region of a skin region in the candidate size image to obtain an abnormal region feature map, where the abnormal region includes a freckle region, a wrinkle region or both, the freckle region is a connected component with an area within a first preset area range, a size less than a first preset size threshold and larger than a second preset size threshold, the wrinkle region is a connected component with an area within a second preset area range, a size within a preset length range, and a width within a preset width range, and the second preset area range is larger than the first preset area range; and
an adjusted image obtaining submodule, configured to clear, in response to a number of times of size adjustment being equal to a preset times threshold, the abnormal regions from a last candidate size image of the candidate size images to obtain the adjusted image.

In some embodiments, the adjusted image obtaining module further includes:
a second candidate image obtaining submodule, configured to perform scaling processing on an eye region in the first candidate image to obtain a second candidate image, and use the second candidate image as the adjusted image.

In some embodiments, the second candidate image obtaining submodule includes:
a scaling ratio obtaining unit, configured to obtain a scaling ratio of each pixel in the eye region of the first candidate image;
a target coordinate obtaining unit, configured to obtain target coordinate data of each pixel based on the scaling ratio and original coordinate data of each pixel; and
a second candidate image obtaining unit, configured to replace original coordinate data of each pixel in the first candidate image with target coordinate data to obtain the second candidate image.

In some embodiments, the scaling ratio obtaining unit includes:
a distance ratio obtaining unit, configured to obtain a distance ratio of each pixel in the eye region of the first candidate image, where the distance ratio indicates that a distance ratio of a pixel closer to a center point of the eye region is smaller;
a scaling ratio obtaining subunit, configured to obtain a scaling ratio of each pixel based on the distance ratio, where the scaling ratio is proportional to the distance ratio.

In some embodiments, the distance ratio obtaining unit includes:
a length obtaining subunit, configured to obtain a major axis length and a minor axis length of the eye region; and
a distance ratio obtaining subunit, configured to obtain the distance ratio of each pixel based on the long axis length, the short axis length, the coordinate data of the center point of the eye region, and the original coordinate data of each pixel.

In some embodiments, the scaling ratio obtaining subunit includes:
a scaling ratio obtaining submodule, configured to obtain the scaling ratio of each pixel based on the distance ratio and an initial value of the scaling ratio.

In some embodiments, the second candidate image obtaining submodule further includes:
a third candidate image obtaining unit, configured to perform size adjustment on the face region in the second candidate image to obtain a third candidate image, and use the third candidate image as the adjusted image.

In some embodiments, the third candidate image obtaining unit includes:
a distance value obtaining subunit, configured to obtain a distance value between the control point C1 of the face region and each pixel in the face region;
a deformation ratio obtaining subunit, configured to obtain a deformation ratio of each pixel based on the distance value, where the deformation ratio is configured to indicate that a moving distance of a pixel farther away from the control point C1 is smaller;
a target pixel obtaining subunit, configured to calculate target pixel data of each pixel based on the coordinate data of the target position M of the control point C1, the coordinate data of the control point C1, and the coordinate data of the target position X of each pixel; and
a third candidate image obtaining subunit, configured to replace pixels of the face region of the second candidate image with the target pixel data to obtain the third candidate image.

In some embodiments, the image quality enhancement processing includes skin smoothing processing, whitening processing, brightening processing or any combination thereof, and the enhanced image obtaining module includes:
a first feature map obtaining submodule, configured to perform skin smoothing processing on the adjusted image to obtain a first skin smoothed feature map;
a second feature map obtaining submodule, configured to adjust a skin smoothing degree of the first skin smoothed feature map to obtain a second skin smoothed feature map;
a skin tone brightened feature map obtaining submodule, configured to perform skin tone brightening processing on the second skin smoothed feature map to obtain a skin tone brightened feature map;
a soft light feature map obtaining submodule, configured to perform soft light processing based on the skin tone brightened feature map and the adjusted image to obtain a soft light feature map; and
an enhanced image obtaining submodule, configured to obtain the enhanced image based on the adjusted image, the second skin smoothed feature map, the skin tone brightened feature map, the soft light feature map and respective weight values.

In some embodiments, the first feature map obtaining submodule includes:
a filtered sub-image obtaining unit, configured to filter a green sub-image of the adjusted image to obtain a filtered sub-image;
a difference sub-image obtaining unit, configured to obtain a pixel data difference of a same pixel in the adjusted image and the filtered sub-image to obtain a difference sub-image;
a compensation sub-image obtaining unit, configured to compensate pixel data of each pixel in the difference sub-image based on preset compensation data to obtain the difference compensation sub-image; and
a first feature map obtaining unit, configured to perform light compensation on the difference compensation sub-image to obtain the first skin smoothed feature map.

In some embodiments, a filtering method used for filtering the green sub-image of the adjusted image includes: averaging filtering, Gaussian filtering, bilateral filtering, guiding filtering, or any combination thereof.

In some embodiments, a filtering kernel of the Gaussian filtering is a circular filtering kernel, and a sum of weight values of the circular filtering kernel is equal to a preset weight value.

In some embodiments, the first feature map obtaining unit includes:
a pixel data comparison subunit, configured to compare pixel data of each pixel of the difference compensation sub-image with preset compensation data;
a target pixel data obtaining subunit, configured to obtain, in response to that the pixel data of each pixel is greater than or equal to the preset compensation data, target pixel data corresponding to the pixel data based on a first light compensation model;
the target pixel data obtaining subunit, further configured to obtain, in response to that the pixel data of each pixel is less than the preset compensation data, target pixel data corresponding to the pixel data based on a second light compensation model.
a pixel data replacing subunit, configured to replace pixel data of each pixel of the difference compensation sub-image with the target pixel data; and
a first feature map obtaining subunit, configured to determine, in response to that the number of times of compensation reaches a preset compensation times threshold, a difference compensation sub-image obtained by a last compensation as the first skin smoothed feature map.

In some embodiments, a value range of the preset compensation times threshold is [1, 10].

In some embodiments, the second feature map obtaining submodule includes:
a grayscale image obtaining unit, configured to obtain a grayscale image corresponding to the adjusted image;
a brightened image obtaining unit, configured to brighten grayscale data of each pixel in the grayscale image based on preset skin smoothing degree data to obtain a grayscale brightened image; and
a second feature map obtaining unit, configured to adjust pixel data of each pixel of the adjusted image based on the first skin smoothed feature map and the grayscale brightened image to obtain the second skin smoothed feature map.

In some embodiments, after identifying the video image frames of the video stream, the enhanced image obtaining module is further configured to in response to the face region not being detected in the video image, perform image quality enhancement processing on the video image frames to obtain an enhanced image; and

the target image obtaining module is further configured to perform rendering processing on the enhanced image to obtain a target image.

According to a third aspect of the embodiments of the present disclosure, there is provided an electrode device, including
a display screen;
a processor, and
a memory for storing computer programs executable by the processor;
where the processor is configured to execute the computer programs in the memory to implement the method according to any one of the first aspect.

According to a third aspect of the embodiments of the present disclosure, there is provided a non-transitory computer-readable storage medium, when an executable computer program in the computer-readable storage medium is executed by a processor, the method described in any one of the first aspects is implemented.

Technical solutions according to the embodiments of the present disclosure can include the following beneficial effects.

It can be learned from the above-mentioned embodiments that, in the solution provided in the embodiments of the present disclosure, identification processing may be performed on video image frames of a video stream to obtain an initial image including a face; alignment processing is performed on a face region in the initial image with a preset skin template to obtain a mapping relationship between the face region and the preset skin template, and a skin region of the face region is adjusted to obtain an adjusted image; the skin region is determined based on the mapping relationship; image quality enhancement processing is performed on the adjusted image to obtain an enhanced image; and rendering processing is performed on the enhanced image to obtain a target image. In this way, in this embodiment, quality of the target image can be improved through face adjustment processing and image quality enhancement processing, which is beneficial to improving user experience.

It should be understood that the above general descriptions and the below detailed descriptions are merely examples and explanation, and non-intended to limit the present disclosure.

### BRIEF DESCRIPTION OF DRAWINGS

The accompanying drawings, which are incorporated in and constitute a part of the specification, illustrate examples consistent with the present disclosure and, together with the description, serve to explain the principles of the disclosure.

FIG. 1 is a flowchart of an image processing method illustrated according to an exemplary embodiment.

FIG. 2 is a flowchart of obtaining a mapping relationship illustrated according to an exemplary embodiment.

FIG. 3 is a schematic diagram of a preset skin template according to an exemplary embodiment.

FIG. 4 is a flowchart of obtaining a mapping relationship illustrated according to an exemplary embodiment.

FIG. 5 is a flowchart of obtaining an adjusted image illustrated according to an exemplary embodiment.

FIG. 6 is a flowchart of obtaining a processed image illustrated according to an exemplary embodiment.

FIG. 7 is a flowchart of obtaining a freckle region illustrated according to an exemplary embodiment.

FIG. 8 is a flowchart of obtaining a first candidate image illustrated according to an exemplary embodiment.

FIG. 9 is a flowchart of obtaining a second candidate image illustrated according to an exemplary embodiment.

FIG. 10 is a schematic diagram of an elliptical region for enlarging an eye illustrated according to an exemplary embodiment.

FIG. 11 is a schematic diagram of a circular region for slimming a face illustrated according to an exemplary embodiment.

FIG. 12 is a flowchart of obtaining a third candidate image illustrated according to an exemplary embodiment.

FIG. 13 is a flowchart of obtaining an enhanced image illustrated according to an exemplary embodiment.

FIG. 14 is a schematic diagram of a filtering kernel illustrated according to an exemplary embodiment.

FIG. 15 is a flowchart of rendering an enhanced image illustrated according to an exemplary embodiment.

FIG. 16 is a schematic diagram of data processing of rendering a pipeline illustrated according to an exemplary embodiment.

FIG. 17 is a flowchart of an image processing method illustrated according to an exemplary embodiment.

FIG. 18 is a diagram of an image processing apparatus illustrated according to an exemplary embodiment.

### DETAILED DESCRIPTION

Various embodiments will be described in detail herein, examples of which are illustrated in the accompanying drawings. When the following descriptions involve the drawings, like numerals in different drawings represent like or similar elements unless stated otherwise. The embodiments described in the following do not represent all embodiments consistent with the present disclosure. On the contrary, they are merely examples consistent with some aspects of the present disclosure as recited in detail in the appended claims. It should be noted that, without conflict, the features in the following embodiments and embodiments can be combined with each other.

To solve the above-mentioned technical problems, embodiments of the present disclosure provide an image processing method and apparatus, an electronic device, and a storage medium that can be applied to a video conference system. The video conference system may include a server and a plurality of electronic devices and the working principle of the video conference system is listed as follows.

In an example, in a video conference, each electronic device participating in the conference may collect a video and upload the video as a video stream to a server, and the server may distribute the video stream to other electronic devices participating in the conference. In this case, the electronic device may obtain video image frames in the video stream, perform the image processing method provided in the present disclosure to obtain a target image corresponding to video image frames, and then display the target image corresponding to video image frames to achieve a real-time beautifying effect.

In an example, in a video conference, each electronic device participating in the conference may collect a video and upload the video as a video stream to a server, and the server may obtain video image frames in the video stream and perform the image processing method provided in the present disclosure to obtain a target image corresponding to video image frames, then form a new video stream according to an order of the respective frames of video images, and distribute the new video stream to respective electronic devices. The electronic device may display the received target image to achieve a real-time beautifying effect.

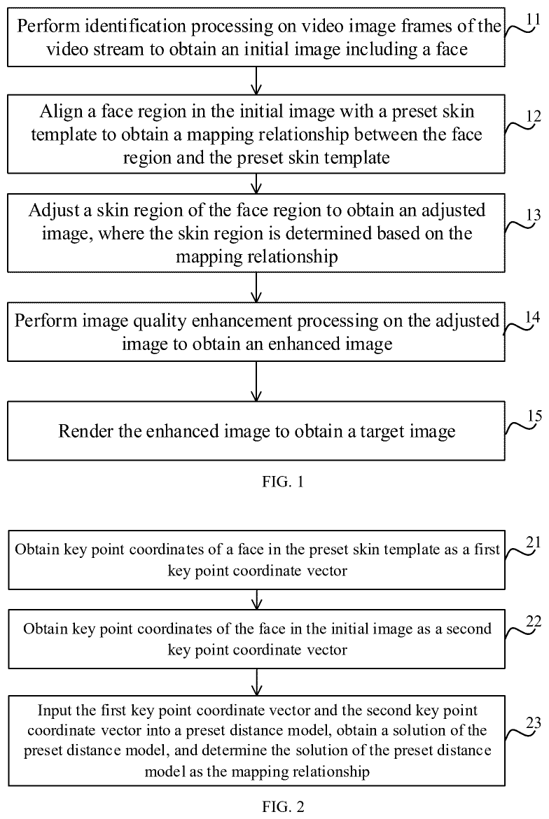

For ease of understanding, the embodiments of the present disclosure describe an image processing method provided by the embodiments of the present disclosure by taking an electronic device in a video conference system as an example, and FIG. 1 is a flowchart of an image processing method according to an exemplary embodiment.

With reference to FIG. 1, the image processing method includes step 11 to step 15.

At step 11, identification processing is performed on video image frames of the video stream to obtain an initial image including a face.

In this embodiment, the electronic device may obtain a video stream uploaded by a peer electronic device in the video conference system, where the video stream includes several frames of video images.

In this embodiment, the electronic device stores a face identification model, and the face identification model may include at least one of the following: a neural network model, a feature face model, principal component analysis (PCA), a support vector machine (SVM), or the like. In an example, the face identification model is implemented by using a neural network model. In another example, the face identification model may be implemented by using a face feature identification library, for example, seetaface or dlib. A technician may select a face identification model according to a specific scenario, and a corresponding solution falls within the protection scope of the present disclosure.

In the embodiment, the face identification model may be trained in advance, and the processor of the electronic device may sequentially input video image frames into the face identification model in chronological order, and obtain the feature point vector corresponding to video image frames output by the face identification model. The feature point vector includes coordinate data and feature point numbers of a preset quantity of feature points. In an example, the preset quantity is 68, and the feature point numbers are from 0 to 67, that is, the feature point vector includes coordinate data of 68 feature points.

In an example, when the feature point vector is null, it indicates that no face is detected in the video image. In another example, when the feature point vector is not null, it indicates that a face is detected in the video image. In this way, in the embodiment, a video image including a face may be obtained through face identification processing, which is subsequently referred to as an initial image, to facilitate description of the solution.

At step 12, a face region in the initial image is aligned with a preset skin template to obtain a mapping relationship between the face region and the preset skin template.

In this step, the processor may perform alignment processing on the face region in the initial image with the preset skin template to obtain the mapping relationship between the face region and the preset skin template, referring to FIG. 2, which includes step 21 to step 23.

At step 21, key point coordinates of a face in the preset skin template are obtained as a first key point coordinate vector.

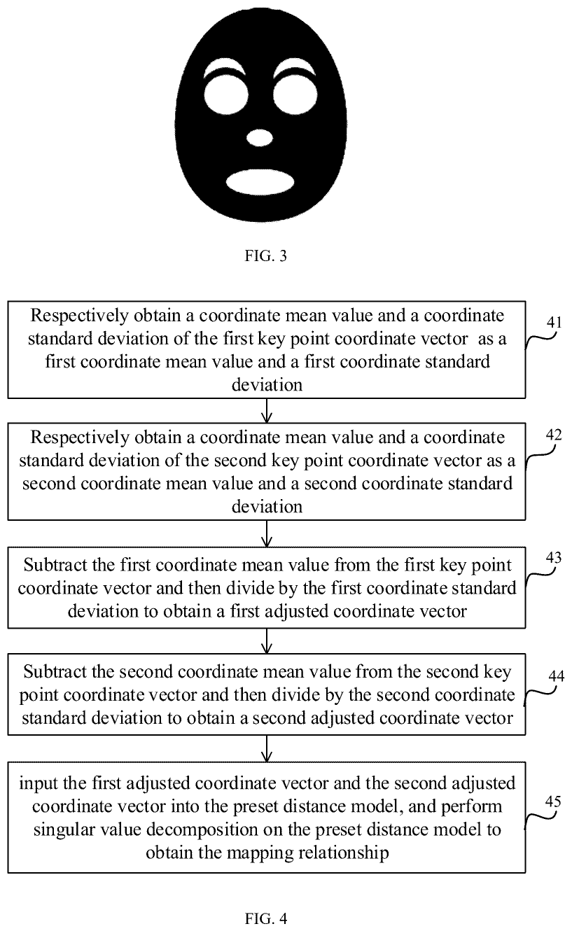

In this step, the preset skin template shown in FIG. 3 is stored in the electronic device. The preset skin template has a water drop shape or an oval shape, and is configured to match the skin region of the face region. A preset quantity of feature points may be set on the preset skin template, and the preset quantity is the same as a quantity of feature points identified by the face identification model, to facilitate subsequent matching.

In this step, the processor may obtain the feature point vector of the preset skin template, for details, reference may be made to the same method for obtaining the feature point of the face in step 11, and details are not described herein again. In this way, the processor may obtain the key point coordinates of the face in the preset skin template, and generate the first key point coordinate vector based on the preset quantity of key point coordinates. The key points may include points of eyebrow, eye, nose tip, triangular region where the nose tip is located, upper lip and lower lip, cheek, lower jaw and the like in the face region, and may be set according to a specific scenario, which is not limited herein.

At step 22, key point coordinates of the face in the initial image are obtained as a second key point coordinate vector.

In this step, the processor may obtain the key point coordinates of the face in the initial image to obtain the second key point coordinate vector, details can be referred to the method in step 11, and will not be described herein again.

At step 23, the first key point coordinate vector and the second key point coordinate vector are input into a preset distance model, a solution of the preset distance model is obtained, and the solution of the preset distance model is determined as the mapping relationship.

In this step, a preset distance model is stored in the electronic device, and the preset distance model is configured to obtain an accumulated value of squared distances between respective key points of the face region of the initial image and respective key points of the preset skin template at the same position. The preset distance model may be represented by formula (1).

$$D = {\sum }_{i = 0}^{67} {‖ sR {p}_{i}^{T} + T - {q}_{i}^{T} ‖}^{2} ; \qquad ( 1 )$$

In the formula (1), D represents an accumulated value of the squared distances; i represents an ordinal number of the key point with a value ranging from 0 to 67; s is a scalar, which represents a geometric scaling degree; R is a 2*2 matrix, which represents a geometric rotation program; T is a two-dimensional vector, which represents a geometric offset degree; pᵢ represents the key point coordinate vector, i.e., the first key point coordinate vector, in the preset skin template; qᵢ represents the key point coordinate vector, i.e., the second key point coordinate vector, of the face region; ∥*∥² represents a square calculated after the difference is made between the two key point vectors; and

$${\sum }_{i = 0}^{67} {‖ * ‖}^{2}$$

represents calculating the accumulated value of the respective squares of 68 distances from 0 to 67.

In this step, in order to ensure that the face region can be more matched with the preset distance model, it needs to be ensured that the preset distance model takes a minimum value. The processor obtains a solution of the preset distance model, referring to FIG. 4, which includes step 41 to step 45.

At step 41, the processor obtains a coordinate mean value and a coordinate standard deviation of the first key point coordinate vector respectively as a first coordinate mean value and a first coordinate standard deviation.

In the step, the processor may obtain a sum value of horizontal coordinates of respective key points in the first key point coordinate vector, and calculate a mean horizontal coordinate value based on the sum value and the number of the key points. The processor may obtain a sum value of the vertical coordinates of respective key points in the first key point coordinate vector, and calculate a mean vertical coordinate value based on the sum value and the number of the key points. The horizontal coordinate mean value and the vertical coordinate mean value constitute a coordinate mean value of the first key point coordinate vector, which is referred to as a first coordinate mean value and is represented by c1.

In the step, the processor may obtain a coordinate standard deviation of each key point in the first key point coordinate vector, which is referred to as a first coordinate standard deviation, as shown in formula (2).

$$s 1 = \sqrt{\frac{{\sum }_{i = 0}^{67} {( {x}_{i} - c 1 )}^{2}}{68}} ; \qquad ( 2 )$$

In formula (2), s1 represents the first coordinate standard deviation, xᵢ represents the horizontal coordinate of each key point, and c1 represents the first coordinate mean value.

At step 42, a coordinate mean value and a coordinate standard deviation of the second key point coordinate vector are respectively obtained as a second coordinate mean value and a second coordinate standard deviation.

In this step, the processor may respectively obtain the coordinate mean value and the coordinate standard deviation of the second key point coordinate vector as a second coordinate mean value c2 and a second coordinate standard deviation s2. The methods of obtaining c2 and s2 can refer to the method in step 41, and will not be described herein again.

At step 43, the first coordinate mean value is subtracted from the first key point coordinate vector and then divided by the first coordinate standard deviation to obtain a first adjusted coordinate vector.

In this step, the processor may subtract the first coordinate mean value from the first key point coordinate vector and then divide by the first coordinate standard deviation to obtain a first adjusted coordinate vector, as shown in formula (3).

$$q 1 = \frac{q - c 1}{s 1} ; \qquad ( 3 )$$

In formula (3), q1 represents the first adjustment coordinate vector.

At step 44, the second coordinate mean value is subtracted from the second key point coordinate vector and then divided by the second coordinate standard deviation to obtain a second adjusted coordinate vector.

In this step, the processor may subtract the second coordinate mean value from the second key point coordinate vector and then divide by the second coordinate standard deviation to obtain a second adjusted coordinate vector, as shown in formula (4).

$$p 1 = \frac{p - c 2}{s 2} ; \qquad ( 4 )$$

In formula (4), p1 represents the second adjustment coordinate vector.

At step 45, the first adjusted coordinate vector and the second adjusted coordinate vector are input into the preset distance model, and singular value decomposition is performed on the preset distance model to obtain the mapping relationship.

In this step, the processor may input the first adjusted coordinate vector and the second adjusted coordinate vector into the preset distance model, that is, formula (1), to obtain formula (5).

$$D = {\sum }_{i = 0}^{67} {‖ sRp {1}_{i}^{T} + T - q {1}_{i}^{T} ‖}^{2} \qquad ( 5 )$$

In this case, the processor may perform singular value decomposition on the preset distance model to obtain the R matrix in formula (5), as shown in formula (6).

$$U , S , V = S V D ( p {1}^{T} \cdot q 1 ) ; \qquad ( 6 )$$

In formula (6), the matrix U represents a column vector, which is a new standard orthogonal basis; the matrix V represents a column vector, which is a standard orthogonal basis of an original domain; and the matrix S represents a diagonal matrix, which represents a ratio (scaling) relationship between a vector in the matrix V and a corresponding vector in the matrix U.

A relationship between the matrix R and the matrices U and V is shown in formula (7).

$$R = {( U * V )}^{T} ; \qquad ( 7 )$$

Then, the processor may obtain the mapping relationship M, as shown in formula (8).

$$M = [ \begin{matrix}{D}_{11} & {D}_{12} & {E}_{11} \\ {D}_{21} & {D}_{22} & {E}_{21} \\ 0 & 0 & 1\end{matrix} ] ; \qquad ( 8 )$$

In formula (8),

$$D = \frac{s 2}{s 1} * R , E = c {2}^{T} - \frac{s 2}{s 1} * R * c {1}^{T} .$$

That is, the processor may align the 68 key points of the preset skin template with the key points of the face region in the initial image after the alignment transformation of the mapping relationship M, to achieve an effect of aligning the face region with the preset skin template in a geometric space.

Finally, the processor may obtain the coordinate data of the pixel of the preset skin template based on the coordinate data of the pixel of the face region and the mapping relationship, as shown in formula (9).

$$[ \begin{matrix}{x}^{*} \\ {y}^{*} \\ 1\end{matrix} ] = M * [ \begin{matrix}x \\ y \\ 1\end{matrix} ] ; \qquad ( 9 )$$

In formula (9), the x* and y* represent the horizontal coordinate and vertical coordinate of the pixel in the preset skin template, respectively; x and y represent the horizontal coordinate and vertical coordinate of the pixel in the face region, respectively.

At step 13, a skin region of the face region is adjusted to obtain an adjusted image, where the skin region is determined based on the mapping relationship.

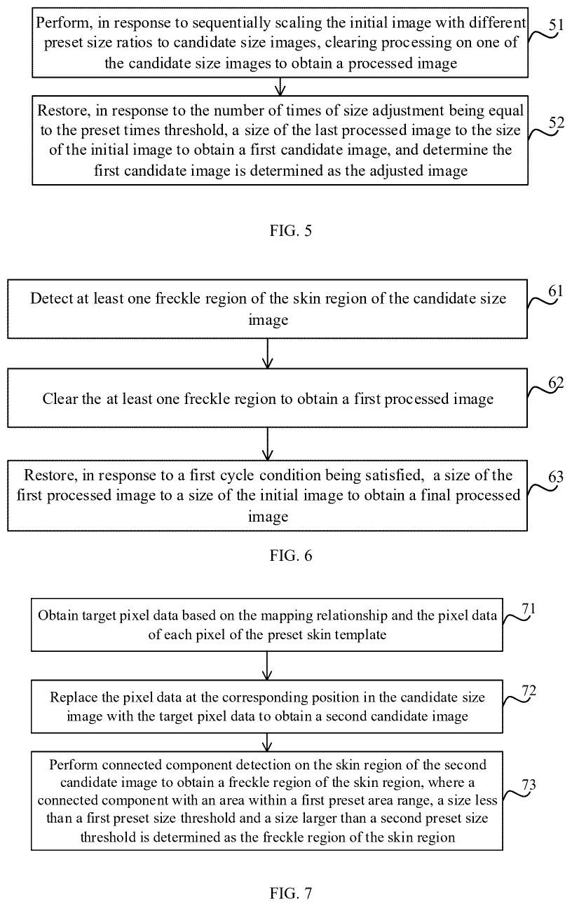

In this embodiment, the processor may perform face adjustment processing on the face region in the initial image to obtain the adjusted image, referring to FIG. 5, which includes step 51 to step 52.

At step 51, in response to sequentially scaling the initial image with different preset size ratios to candidate size images, clearing processing is performed on one of the candidate size images to obtain a processed image.

In the embodiment, a preset size ratio is stored in the electronic device, and the preset size ratio refers to a ratio at which the initial image is magnified or reduced, and may be set according to a specific scenario. In an example, the preset size ratio refers to a magnification ratio and may be set to a preset number, for example, 2 times, 4 times, or 8 times. In this way, the processor may sequentially magnify the initial image by 2 times, 4 times, 8 times, and the like according to the preset size ratios.

In this embodiment, the processor may sequentially scale the initial image with the preset size ratios to obtain the candidate size images. Then, the electronic device may perform clearing processing on the candidate size image to clear an abnormal region from the candidate size image, where the abnormal region includes a freckle region, a wrinkle region or both.

In an embodiment, the processor may perform clearing processing on the candidate size image to obtain the processed image, referring to FIG. 6, which includes step 61 to step 63.

At step 61, the processor may detect at least one freckle region of the skin region of the candidate size image, referring to FIG. 7, which includes step 71 to step 73.

At step 71, the processor may obtain target pixel data based on the mapping relationship and the pixel data of each pixel of the preset skin template, and an obtaining method is shown in formula (9), and details are not described herein again.

At step 72, the processor may replace the pixel data at the corresponding position in the candidate size image with the target pixel data to obtain a second candidate image.

At step 73, the processor may perform connected component detection on the skin region of the second candidate image to obtain a freckle region of the skin region, where a connected component with an area within a first preset area range, a size less than a first preset size threshold and a size larger than a second preset size threshold is determined as the freckle region of the skin region.

In this step, the processor may obtain a grayscale image corresponding to the candidate size image, and reference may be made to a method of converting an RGB image into a YUV image, which is not described herein again.

The processor may convert the grayscale image of the candidate size image to binary images based on respective preset thresholds to obtain multiple frames of binary images. The value range of the preset thresholds is [T1, T2], and the step length is t, the respective preset thresholds are T1, T1+t, T1+2t, T1+3t, . . . , and T2 in sequence.

Then, the processor may respectively obtain connected regions in multiple frames of binary images to obtain multiple connected components in multiple frames of binary images. The connected region refers to a closed region obtained when a boundary of the binary image is detected, and each connected region may be a freckle in the binary image.

Then, the processor may classify the connected components based on distances between center points of corresponding connected components in the frames of binary images, to obtain a plurality of connected components with distances between corresponding center points less than a preset distance threshold. If a distance between center points of corresponding connected components in the frames of binary images is less than the preset distance threshold, it indicates that the multiple frames of binary images include a same connected component, and the connected component has an extremely high probability of being a freckle, and further may be a freckle region of the grayscale image.

In other words, in this example, the processor may cluster connected components in the frames of binary images, and classify the connected components based on respective cluster groups.

Furthermore, the processor may obtain positions of the plurality of connected components and determine a connected component with a size less than the first preset size threshold and larger than the second preset size threshold of the plurality of connected components as the freckle region of the skin region, where each position of the plurality of connected components refers to a mean value of center point coordinates of corresponding connected components in respective frames of binary images, and each size of the plurality of connected components refers to a radius length of a circumscribed circle when an area of the connected component is within a preset area range. The first preset area range is [6, 100] pixels.

Finally, the processor may determine a connected component with a size less than the first preset size threshold and larger than the second preset size threshold of the plurality of connected components as the freckle region of the skin region, to obtain at least one freckle region. A value range of the preset size is [1, 5]. A value of the first preset size threshold is 5, and a value of the second preset size is [1, 3]. In this way, in this step, a connected component that is too small or too large can be omitted.

It should be noted that, after the freckle region is determined, the freckle region is marked on the preset skin template to mark the position and size of the freckle region.

At step 62, the processor may clear the at least one freckle region to obtain a first processed image.

In this step, the processor may obtain pixel data around the freckle region, and fill pixels of the freckle region by using the pixel data, for example, directly filling or averaging the pixel data and then filling the averaged pixel data in the pixels, such that the obtained pixels of the freckle region are the same as or similar to pixels of surrounding neighbours, and an effect of eliminating the freckle region is achieved. In this way, the processor may obtain the first processed image.

At step 63, in response to a first cycle condition being satisfied, the processor may restore a size of the first processed image to a size of the initial image to obtain a final processed image, where the first cycle condition is that a number of times of freckle region detection is equal to a first preset times threshold or a number of the freckle regions is less than a first preset quantity threshold.

In this step, the processor may determine whether a first cycle condition is currently satisfied, where the first cycle condition is that a number of times of freckle region detection is equal to the first preset times threshold or a quantity of freckle regions is less than the first preset quantity threshold. A value range of the first preset times threshold is [1, 10], and in an example, a value of the first preset times threshold is 3. A value range of the first preset quantity threshold is [1, 10], and in an example, a value of the first preset quantity threshold is 2.

Taking the first cycle condition being that the number of times of detecting the freckle region is equal to the first preset times threshold as an example, the processor may continuously perform step 61 and step 62, and record the number of times of execution, due to every time step 61 is executed, freckle region detection is performed once, the number of times of executions is equal to the number of times of detections for detecting the freckle region. When the number of times of detecting the freckle region is less than the first preset times threshold, the processor may determine that the first cycle condition is not satisfied, and continuously perform step 61, until the number of times of detecting the freckle region is equal to the first preset times threshold, and determine that the first cycle condition is satisfied, stop performing step 61.

Taking the first cycle condition being that the quantity of freckle regions is less than the first preset quantity threshold as an example, the processor may continuously perform step 61 and step 62, and record the number of detected freckle regions each time, and when the number of detected freckle regions is larger than or equal to the first preset quantity threshold, determine that the first cycle condition is not satisfied, and continue to perform step 61, and until the number of detected freckle regions is less than the first preset quantity threshold, determine that the first cycle condition is satisfied and stop performing step 61.

In this step, by setting the first cycle condition, the skin region of the same candidate size image can be detected for multiple times, which can avoid missing detection of the freckle region and ensure the effect of clearing the freckle region.

In an embodiment, the processor may further determine whether there is a wrinkle region when no freckle region is detected. A method of detecting the wrinkle region is similar to a method of detecting the freckle region, and a difference lies in that areas and sizes of the wrinkle region and the freckle region are different, and the wrinkle region different from the freckle region may be selected by adjusting a screening condition of the connected component, that is, a subsequent second preset condition.

For example, the second preset condition may include: the second preset area range is [6, 200] pixels, the preset length range is [5, 20] pixels, and the preset width range is [1, 5] pixels, which may be set according to a specific scenario, which is not limited herein.

When at least one wrinkle region is detected, the processor may perform clearing processing on the wrinkle region satisfying the second preset condition in the candidate size image to obtain a second processed image. The clearing processing method of the wrinkle region is the same as the clearing processing method of the freckle region, and reference may be made to the method of clearing the freckle region illustrated in FIG. 6, which is not repeated herein.

The processor may determine whether a second cycle condition is satisfied, where the second cycle condition is that a number of times of wrinkle region detection is equal to a second preset times threshold or a quantity of wrinkle regions currently detected is less than a second preset quantity threshold. For a setting manner of the second preset times threshold, refer to a setting manner of the first preset times threshold. For a setting manner of the second preset quantity threshold, refer to the setting manner of the first preset quantity threshold. In response to the second cycle condition being satisfied, the processor may restore a size of the second processed image to the size of the initial image to obtain a final processed image, that is, the adjusted image.

In an embodiment, when one of the abnormal regions includes a wrinkle region, the processor may detect the wrinkle region of the skin region of the candidate size image; then, in response to detecting at least one wrinkle region, the processor may perform clearing processing on the at least one wrinkle region in the candidate size image that satisfies the second preset condition to obtain a third processed image; and then, in response to a second cycle condition being satisfied, restore a size of the third processed image to the size of the initial image to obtain a final processed image, where the second cycle condition is that a number of times of wrinkle region detection is equal to a second preset times threshold or a quantity of wrinkle regions currently detected is less than a second preset quantity threshold.

In another embodiment, the processor may further first detect the wrinkle region for clearing processing, and then detect the freckle region for clearing processing, where a detection method and a clearing processing method are the same as those in the above-mentioned embodiments, and a difference lies in that a sequence of detecting the wrinkle region and the freckle region changes, and an effect of clearing abnormal regions may also be achieved.

At step 52, in response to the number of times of size adjustment being equal to the preset times threshold, a size of the last processed image is restored to the size of the initial image to obtain a first candidate image, and the first candidate image is determined as the adjusted image.

In the embodiment, each time the size of the initial image is adjusted, the processor may record the number of times of size adjustment, and compare the number of times of adjusting to the preset quantity threshold. When the number of times of size adjustment is equal to the preset times threshold, the processor may restore a size of the last (abnormal regions having been cleared) processed image to the size of the initial image to obtain the first candidate image. In some embodiments, the processor may use the first candidate image as the adjusted image.

It is to be understood that, the embodiment shown in FIG. 6 discloses a method of obtaining the abnormal regions of a candidate size image every time and clearing the abnormal regions of the candidate size image, that is, a method for clearing the abnormal regions of one candidate size image each time.

In practical applications, the processor may obtain each candidate size image, and obtain abnormal regions of the candidate size image and mark positions of the abnormal regions; and after a preset number of times of scaling, perform clearing processing on the (last) candidate size image based on marks of the abnormal regions of the preset number of candidate size images. That is, the abnormal regions of the plurality of candidate size images are obtained, and all the abnormal regions are cleared only at the last time. Referring to FIG. 8, the processor may perform clearing processing on the candidate size image to obtain a processed image, the method includes step 81 to step 83.

At step 81, the processor may align the face region in the initial image with the preset skin template to obtain a mapping relationship between the face region and the preset skin template.

In this step, the method for obtaining the mapping relationship is the same as the method for obtaining the mapping relationship in step 33.

At step 82, the processor may obtain, in response to sequentially scaling the initial image to candidate size images with different preset sizes, an abnormal region of a skin region in the candidate size image to obtain an abnormal region feature map, where the abnormal region includes a freckle region, a wrinkle region or both.

In this step, the processor may sequentially scale the initial image to candidate size images with different preset sizes. For example, a preset size ratio is stored in the electronic device, and the preset size ratio refers to a ratio by which the initial image is magnified or reduced, and may be set according to a specific scenario. In an example, the preset size ratio refers to a magnification ratio and may be set to a preset quantity, for example, 2 times, 4 times, or 8 times. In this way, the processor may sequentially magnify the initial image by 2 times, 4 times, 8 times, and the like according to the preset size ratios.

In this step, the processor may in response to sequentially scaling the initial image to candidate size images with different preset sizes, obtain abnormal regions of the skin region in one of the candidate size images. When the abnormal regions are freckle regions, a method for obtaining the freckle region is the same as the method for obtaining the freckle region illustrated in FIG. 7, details can be referred to FIG. 7, which will not be further repeated here. When the abnormal regions are wrinkle regions, the method for obtaining the wrinkle region is similar as the method for obtaining the freckle region illustrated in FIG. 7, and details are not described herein again.

In this step, after the abnormal regions of each candidate size image is obtained, the abnormal regions can be marked on the preset skin template, that is, the position and size of the abnormal regions are marked, such that the abnormal regions of the preset number of candidate size images can be accumulated.

At step 83, the processor may clear, in response to the number of times of size adjustment being equal to the preset times threshold, the abnormal regions from the last candidate size image to obtain the first candidate image.

In this step, when the number of times of size adjustment is equal to the preset times threshold, the processor performs clearing processing on the abnormal regions obtained in step 82 based on the last candidate size image. In other words, abnormal regions are detected in the candidate size images of different sizes, and all the detected abnormal regions obtained from the candidate size images of different sizes are cleared from the last candidate size image to obtain the first candidate image. For example, if there are 3 candidate size images, the names of which are candidate 1, candidate 2, and candidate 3 respectively, and the numbers of the abnormal regions are 5, 6, and 7 respectively, the processor needs to perform clearing processing on the (5+6+7=) 18 abnormal regions in the candidate size image named candidate 3.

It should be noted that, when the scaling ratio is set reasonably and the screening condition is set reasonably, the abnormal regions in each candidate size image can achieve the effect of not overlapping each other, for example, the abnormal regions in the candidate 1 cannot become the abnormal regions in the candidate 2 due to the too small area of abnormal regions in candidate 1, and the abnormal regions in the candidate 2 cannot become the abnormal regions in the candidate 3 due to the too small area of abnormal regions in candidate 2, which is beneficial to improving the effect of clearing the abnormal regions of the skin region.

In an embodiment, the first candidate image obtained in step 83 may be used as the adjusted image, and in this case, step 13 may be performed.

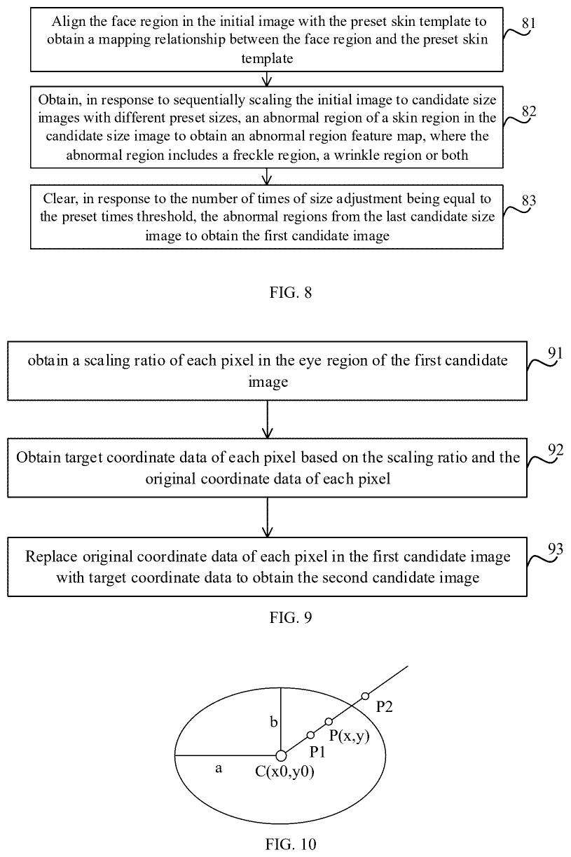

In another embodiment, the processor may scale an eye region in the first candidate image to obtain a second candidate image, referring to FIG. 9, the method includes step 91 to step 93.

At step 91, the processor obtains a scaling ratio of each pixel in the eye region of the first candidate image.

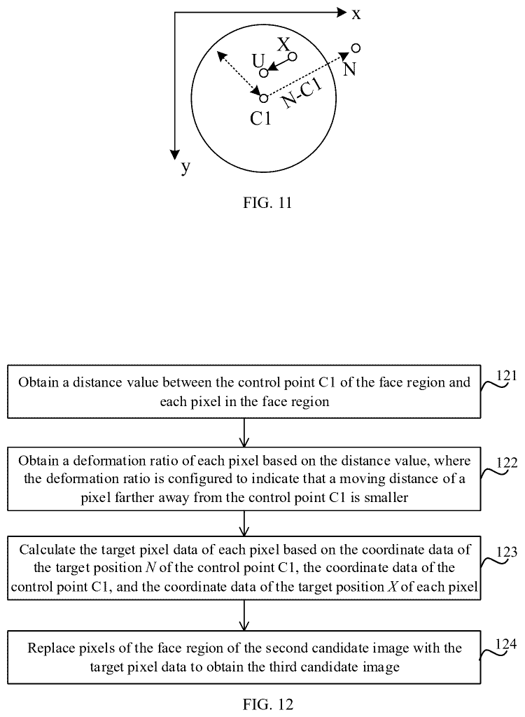

Considering that the shape of the human eye is close to an ellipse, in this embodiment, an elliptical region is established by using the center point C of the eye, and the elliptical region is magnified. Referring to FIG. 10, for any position point P(x, y) in the elliptical region, a position is selected from straight lines CP passing through center points C(x0, y0) and P(x, y) as a new position. If the new position is between the point C and the point P, the new position is P1, and the eye can be reduced in this scenario; and if the new position is on an extension line of the straight-line CP, the new position is P2, and the eye can be magnified in this scenario.

The processor may obtain a distance ratio m between a distance between the point P(x, y) and the center point C(x0, y0) and the elliptical radius combination, that is, the processor may obtain a distance ratio of each pixel in the eye region of the first candidate image, where the distance ratio indicates that a distance ratio of a pixel closer to the center point of the eye region is smaller, as shown in formula (10).

$$m = \frac{{( x - x 0 )}^{2} * {b}^{2} + {( y - y 0 )}^{2} * {a}^{2}}{{a}^{2} * {b}^{2}} ; \qquad ( 10 )$$

In the formula (10), m represents the distance ratio, which represents that pixels closer to the center point C have a smaller scaling ratio, while pixels farther away from the center point C have a larger scaling ratio; x and y respectively represent the horizontal coordinate and vertical coordinate of the pixel P; x0 and y0 respectively represent the horizontal coordinate and vertical coordinate of the center point C; a represents a major axis of the ellipse, a=2*distance (left eye corner, right eye corner); b represents a minor axis of the ellipse, b=2*distance (upper eye skin, lower eye skin); distance represents a function for calculating the distance between two points.

Before calculating the distance ratio function (distance) for a and b, a coefficient of 2 was set to indicate that the eye region was enlarged, achieving synchronous scaling of the surrounding area of the eye, thereby ensuring a more natural eye scaling effect.

Then, the processor may obtain a scaling ratio of each pixel based on the distance ratio, where the scaling ratio is directly proportional to the distance ratio, as shown in formula (11).

$$K = 1 - K 1 * {( 1 - m )}^{2} ; \qquad ( 11 )$$

In formula (11), K represents a scaling ratio, K1 represents a first initial value of the scaling ratio, and m represents a distance ratio.

At step 92, target coordinate data of each pixel is obtained based on the scaling ratio and the original coordinate data of each pixel.

In this step, the processor may obtain target coordinate data of each pixel based on the scaling ratio and the original coordinate data of each pixel, as shown in formula (12).

$$\begin{matrix}{x}^{′} = x 0 + K ( x - x 0 ) \\ {y}^{′} = y 0 + K ( y - y 0 ) ;\end{matrix} \qquad ( 12 )$$

In the formula (12), x and y represent the horizontal coordinate and vertical coordinate of the original coordinate data of each pixel, respectively; x′ and y′ represent the horizontal coordinate and vertical coordinate of the target coordinate data of each pixel, respectively; and x0 and y0 represent the horizontal coordinate and vertical coordinate of the center point C, respectively.

At step 93, original coordinate data of each pixel in the first candidate image is replaced with target coordinate data to obtain the second candidate image.

In this step, the processor may replace original coordinate data (x, y) of each pixel in the first candidate image with target coordinate data (x′, y′) to obtain the second candidate image.

In this way, in this embodiment, the eye region in the first candidate image is magnified, to achieve an eye magnification effect.

In an embodiment, the second candidate image may be used as the adjusted image, and in this case, the processor may jump to step 13.

In an embodiment, the processor may perform face thinning processing on adjusted image of the user, referring to FIG. 11, a control point C1 is set for the face region, and all pixels within the circular region with C1 as the center and a radius length of Rmax are moved. N is a target point of the face region, and when moving the control point C1 toward the target point N, all points in the circular region need to be moved.

A point X is any point in the circular region, and when moving the control point C1 to the target point N, the pixel data of the point X should move from the point U. In this way, when the coordinates of the points C1, N and X and the radius length Rmax are determined, the coordinate data of the point U may be calculated; then, the pixel data of the point U is replaced with the pixel data of the point X, thereby achieving the image deformation effect.

In this embodiment, the processor may perform size adjustment on the face region in the second candidate image to obtain a third candidate image, referring to FIG. 12, the method includes step 121 to step 124.

At step 121, the processor may obtain a distance value between the control point C1 of the face region and each pixel in the face region. For example, the distance value between point X and point C1 is d=distance (C1, X).

At step 122, the processor may obtain a deformation ratio of each pixel based on the distance value, where the deformation ratio is configured to indicate that a moving distance of a pixel farther away from the control point C1 is smaller. In this step, the deformation ratio of each pixel is shown in formula (13).

$$f = 1 - \frac{d}{Rmax} ; \qquad ( 13 )$$

In formula (13), f represents the deformation ratio, the pixel farther away from the center point C1 will have a smaller deformation, and the pixel closer to the center point C1 will have a larger deformation; d represents the distance between the pixel X and the control point C1; Rmax represents the radius length of the deformation area around the control point C1.

At step 123, the processor may calculate the target pixel data of each pixel based on the coordinate data of the target position N of the control point C1, the coordinate data of the control point C1, and the coordinate data of the target position X of each pixel. In this step, the processor obtains the target pixel data as shown in formula (14).

$$U = X - {f}^{2} * \frac{K 2}{2} * ( N - C 1 ) ; \qquad ( 14 )$$

In formula (14), U represents the target pixel data, X represents the pixel data of point X, N represents the pixel data of point N, C1 represents the pixel data of the control point C1, f represents the deformation ratio, and K2 represents a second initial value of the scaling ratio.

At step 124, the processor may replace pixels of the face region of the second candidate image with the target pixel data to obtain the third candidate image.

In this step, the processor may use the third candidate image as the adjusted image.

It should be noted that methods of clearing abnormal regions, enlarging eyes and thinning faces are described in the embodiment. In some possible embodiments, the order of clearing abnormal regions, enlarging eyes and thinning faces may be adjusted, for example, various combination solutions such as a combination of clearing abnormal regions, thinning faces and enlarging eyes, a combination of thinning faces, enlarging eyes and clearing abnormal regions, a combination of enlarging eyes, thinning faces and clearing abnormal regions, a combination of enlarging eyes, clearing abnormal regions and thinning faces, a combination of thinning faces, clearing abnormal regions and enlarging eyes, etc., and the obtained solution falls within the protection scope of the present disclosure without conflict.

At step 14, image quality enhancement processing is performed on the adjusted image to obtain an enhanced image.

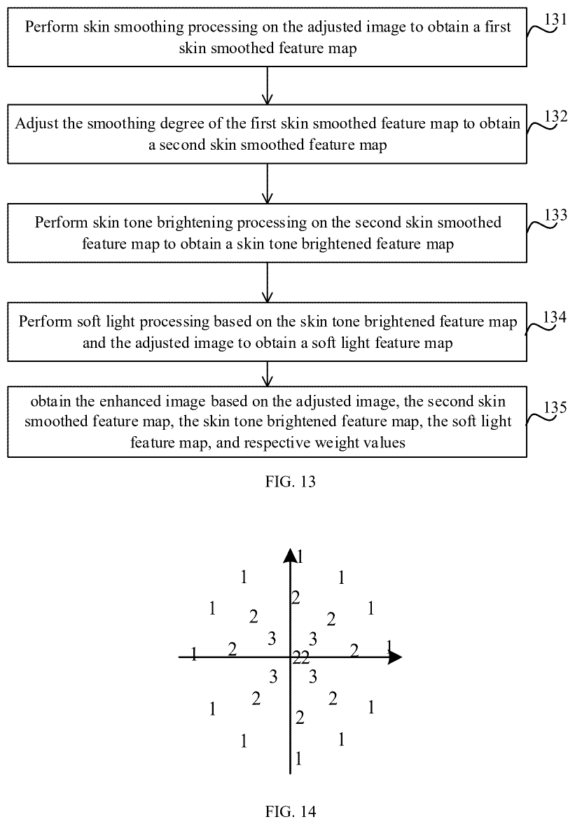

In this embodiment, the processor may perform image quality enhancement processing on the adjusted image to obtain an enhanced image, referring to FIG. 13, the method includes step 131 to step 135.

At step 131, the processor may perform skin smoothing processing on the adjusted image to obtain a first skin smoothed feature map.

In this step, the processor may filter each pixel of the green sub-image of the adjusted image to obtain a filtered sub-image. A filtering method used for filtering processing includes one of: averaging filtering, Gaussian filtering, bilateral filtering, or guided filtering. In an example, the filtering processing is implemented by using Gaussian filtering, a filtering kernel of the Gaussian filtering is a circular filtering kernel, and a sum of weight values of the circular filtering kernel is equal to a preset weight value. In an example, the value of the preset weight value is 62, and the circular filter kernel is shown in FIG. 14.

Then, the processor may obtain a pixel data difference value of a same pixel in the adjusted image and the filtered sub-image to obtain a difference sub-image.

Then, the processor may compensate pixel data of each pixel in the difference sub-image based on preset compensation data to obtain the difference compensation sub-image. Taking the preset compensation data being 0.5 as an example, the difference compensation sub-image=green sub-image−filtered pixel value+0.5.

It should be noted that the gray value of the green sub-image after filtering is less than 0, and the gray value of the skin under normal conditions is positive, so it is necessary to add a preset compensation data for normal compensation. After compensation, pixel data of pixels of the difference compensation sub-image is less than 0.5, and a value of normal skin is larger than 0.5.

Finally, the processor may perform light compensation on the difference compensation sub-image to obtain the first skin smoothed feature map.

Considering that the difference compensation sub-image is grayish, in this step, light compensation is applied to the difference compensation sub-image to make the features of the difference compensation sub-image more prominent. In an example, the processor performs at least one light compensation on the difference compensation sub-image. For example, the processor may compare pixel data of each pixel of the difference compensation sub-image with preset compensation data; when the pixel data of each pixel is greater than or equal to the preset compensation data (for example, 0.5), the processor may obtain target pixel data corresponding to the pixel data based on a first light compensation model; when the pixel data of each pixel is less than the preset compensation data, the processor may obtain target pixel data corresponding to the pixel data based on a second light compensation model; and then, the processor may replace the pixel data of each pixel of the difference compensation sub-image with the target pixel data. Finally, in response to that the number of times of compensation reaches a preset compensation times threshold, the processor may determine that the difference compensation sub-image obtained by the last compensation is the first skin smoothed feature map. In other words, the processor performs light compensation processing on the difference compensation sub-image, as shown in formula (15).

$$y = \{ \begin{matrix}2 * {x}^{2} , x < 0.5 \\ 1 - 2 * {( 1 - x )}^{2} , x \geq 0.5\end{matrix} ; \qquad ( 15 )$$

In formula (15), x represents an input value, y represents an output value, y=2*x² represents a first light compensation model, and y=1−2*(1−x)² represents a second light compensation model.

In an example, a value range of the preset compensation times threshold is [1, 10]. After the light compensation processing, the processor may obtain the first skin smoothed feature map, which is denoted as Highpass.

At step 132, the processor may adjust the smoothing degree of the first skin smoothed feature map to obtain a second skin smoothed feature map.

In this step, the processor may obtain a grayscale image corresponding to the adjusted image, as shown in formula (16).

$$gray = 0.299 * r + 0.587 * g + 0.114 * b ; \qquad ( 16 )$$

In formula (16), r, g and b respectively represent pixel data of red, green and blue of the adjusted image, and gray represents a gray value of a pixel of the grayscale image.

Then, the processor may brighten the grayscale data of each pixel in the grayscale image based on the preset skin smoothing degree data, to obtain a grayscale brightened image, as shown in formula (17).

$$mgray = {gray}^{1 - 0.6 * K 3} ; \qquad ( 17 )$$

In formula (17), K3 represents a skin smoothing degree set by the user, and a value range of the skin smoothing degree is [0, 1], the larger K3 is, the higher the skin smoothing degree is.

Then, the processor may adjust the pixel data of each pixel of the adjusted image based on the first skin smoothed feature map and the grayscale brightened image, to obtain the second skin smoothed feature map, as shown in formula (18).

$$[ \begin{matrix}{r}^{′} \\ {g}^{′} \\ {b}^{′}\end{matrix} ] = [ \begin{matrix}r \\ g \\ b\end{matrix} ] + ( [ \begin{matrix}r \\ g \\ b\end{matrix} ] - [ \begin{matrix}Highpass \\ Highpass \\ Highpass\end{matrix} ] ) * mgray * 0.1 ; \qquad ( 18 )$$

In formula (18),

$$[ \begin{matrix}r \\ g \\ b\end{matrix} ]$$

respectively represent the pixel data of the pixels (red pixel, green pixel and blue pixel) of the first skin smoothed feature map,

$$[ \begin{matrix}{r}^{′} \\ {g}^{′} \\ {b}^{′}\end{matrix} ]$$

respectively represent the pixel data of the pixels (red pixel, green pixel and blue pixel) of the second skin smoothed feature map.

At step 133, the processor may perform skin tone brightening processing on the second skin smoothed feature map to obtain a skin tone brightened feature map.

In this step, the processor may obtain the pixel data of the second skin smoothed feature map after skin smoothing processing, as shown in formula (19).

$$[ \begin{matrix}{r}^{″} \\ {g}^{″} \\ {b}^{″}\end{matrix} ] = [ \begin{matrix}{r}^{′ ∧} 1 - 0.3 * K 2 ) \\ {g}^{′ ∧} 1 - 0.3 * K 2 ) \\ {b}^{′ ∧} 1 - 0.3 * K 2 )\end{matrix} ] ; \qquad ( 19 )$$

In formula (19),

$$[ \begin{matrix}{r}^{″} \\ {g}^{″} \\ {b}^{″}\end{matrix} ]$$

represent the pixel data after skin smoothing processing.

Then, the processor may perform skin tone brightening processing on the second skin smoothed feature map, as shown in formula (20).

$$[ \begin{matrix}r l \\ g l \\ b l\end{matrix} ] = [ \begin{matrix}1 \\ 1 \\ 1\end{matrix} ] - ( [ \begin{matrix}1 \\ 1 \\ 1\end{matrix} ] - [ \begin{matrix}{r}^{″} \\ {g}^{″} \\ {b}^{″}\end{matrix} ] ) * ( [ \begin{matrix}1 \\ 1 \\ 1\end{matrix} ] - [ \begin{matrix}r \\ g \\ b\end{matrix} ] ) ; \qquad ( 20 )$$

In formula (20),

$$[ \begin{matrix}r l \\ g l \\ b l\end{matrix} ]$$

represent pixel data of pixels of the skin tone brightened feature map.

In this step, original pixel data is added by pixel data after skin smoothing processing through screen color filtering mode, the standard color values of the upper and lower pixels are inverted and multiplied to output a result that is brighter than the pixel data of both, achieving the effect of brightening skin tone.

At step 134, the processor may perform soft light processing based on the skin tone brightened feature map and the adjusted image to obtain a soft light feature map.

In this step, the processor obtains the soft light feature map as shown in formula (21).

$$[ \begin{matrix}rr \\ g r \\ br\end{matrix} ] = 2 * [ \begin{matrix}r \\ g \\ b\end{matrix} ] * [ \begin{matrix}{r}^{″} \\ {g}^{″} \\ {b}^{″}\end{matrix} ] + [ \begin{matrix}r \\ g \\ b\end{matrix} ] * [ \begin{matrix}r \\ g \\ b\end{matrix} ] - 2 * [ \begin{matrix}r \\ g \\ b\end{matrix} ] * [ \begin{matrix}r \\ g \\ b\end{matrix} ] * [ \begin{matrix}{r}^{″} \\ {g}^{″} \\ {b}^{″}\end{matrix} ] ; \qquad ( 21 )$$

In formula (21),

$$[ \begin{matrix}rr \\ g r \\ br\end{matrix} ]$$

represent pixel data of pixels of the soft light feature map.

At step 135, the processor may obtain the enhanced image based on the adjusted image, the second skin smoothed feature map, the skin tone brightened feature map, the soft light feature map, and respective weight values.

In this step, the processor obtains the enhanced image as shown in formula (22).

$$[ \begin{matrix}r d s t \\ g d s t \\ b d s t\end{matrix} ] = [ \begin{matrix}r \\ g \\ b\end{matrix} ] * a + [ \begin{matrix}r l \\ g l \\ b l\end{matrix} ] * b + [ \begin{matrix}rr \\ g r \\ br\end{matrix} ] * c + [ \begin{matrix}b r i g h t \\ b r i g h t \\ b r i g h t\end{matrix} ] ; \qquad ( 22 )$$

In formula (22),

$$[ \begin{matrix}r d s t \\ g d s t \\ b d s t\end{matrix} ]$$

represent pixel data pixels of the enhanced image, a+b+c=1, and bright is a preset brightening parameter.

At step 15, the enhanced image is rendered to obtain a target image.

In this embodiment, an Open Graphics Library (OpenGL) object is pre-deployed in the electronic device, an API interface provided by the OpenGL is invoked by invoking an OpenGL instruction to write rendering operations for the enhanced image, and the enhanced image is finally displayed in a display of the electronic device. In this way, in the embodiment, the enhanced image can be directly rendered and displayed, which can ensure real-time performance in a video conference scenario.

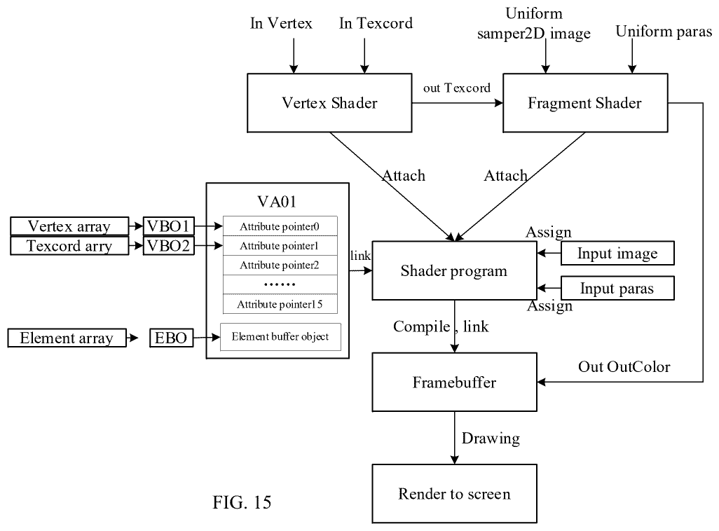

In an embodiment, an OpenGL ES 3.0 is deployed in the electronic device, and a rendering processing thereof is shown in FIG. 15.

(1) A vertex shader Vertex Shader is defined, all input vertex attributes are declared in the vertex shader by using an in keyword, the vertex shader in the present disclosure is relatively simple, only two input vertex attributes need to be declared, and the two input vertex attributes are input vertex coordinates Vertex and input texture coordinates Texcord. Using the out keyword, all output vertex attributes are declared in the vertex shader, outputting texture coordinates Texcord.

(2) A fragment shader Fragment Shader is defined, a texture coordinate input attribute in the fragment shader is declared by using an in keyword, and a global variable attribute in the fragment shader is declared by using a uniform keyword. The input global variable of the fragment shader includes image object sample2D image, parameter array paras, and texture coordinate output by the vertex shader. Using the out keyword, all output attributes are declared in the fragment shader, and the color value OutColor corresponding to the texture coordinate is output.

(3) A shader program Shader program is defined, the vertex shader Vertex Shader and the fragment shader Fragment Shader are attached to Shader program.

(4) A vertex coordinate array Vertex array, a texture coordinate array Texcord array, and an element index array Element array are defined. Due to the square shape of the image, these three arrays are fixed and their defined values are as follows:

```
float vertices_array[]= {
// positions positions
  -1.0f, 1.0f, 0.0f, / / top right top right
  -1.0f, 1.0f,0.0f, / / bottom right bottom right
  1.0f -1.0f, 0.0f, / / bottom left bottom left
  1.0f, 1.0f, 0.0f, / / top left top left
};
float textureCords_array []= {
  0.0f,0.0f, //TexCord 0
  0.0f,1.0f, //TexCord 1
  1.0f,1.0f, //TexCord 2
  1.0f,0.0f, //TexCord 3
};
Unsighed int element_array []= {
  0,1,3, //first triangle
  1,2,3, //second triangle
};
```

(5) A vertex array object VAO1 (Vertex Array Object) is defined, and binding activation is performed;

(6) A vertex buffer object VBO1 (Vertex Buffer Object) is defined, a glBufferData function is called, and a previously defined vertex coordinate array Vertex array is copied to a memory buffered by the VBO1.

A vertex buffer object VBO2 (Vertex Buffer Object) is defined, a glBuffer Data function is called, and a previously defined texture coordinate array Texcord array is copied to a memory buffered by the VBO2.

An element buffer object EBO (Element Buffer Object) is defined, and a previously defined element index array Element array is copied to a memory buffered by the EBO.

(7) VBO1 is linked to vertex attribute 0 (vertex coordinate) of vertex shader Vertex Shader and attribute 0 is activated; VBO2 is linked to vertex attribute 1 (texture coordinate) of vertex shader Vertex Shader and attribute 1 is activated;

(8) A texture object Texture is defined, a video frame image is input, and data is copied to a memory of the texture object.

(9) The texture Texture is assigned to the image object sample 2D image of the fragment shader.

(10) Various parameters of portrait beautifying are defined and assigned to the parameters paras of the fragment shader.

(11) The shader program is compiled and linked, VAO1 is activated, FrameBuffer is bound.

(12) An image is drawn and rendered to a screen.

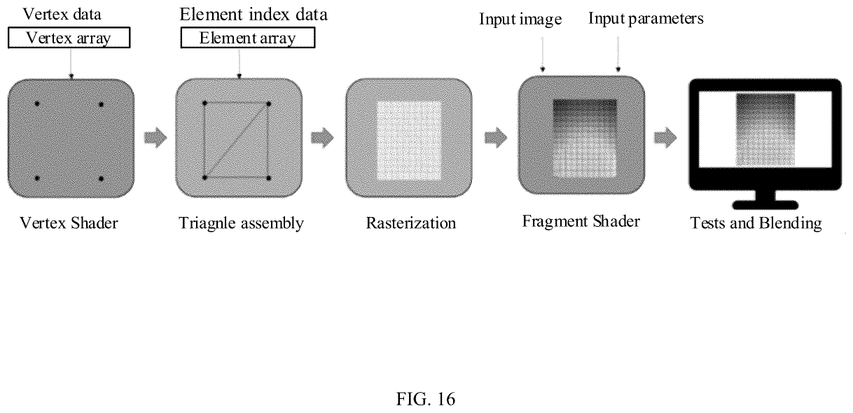

In this embodiment, a schematic abstract diagram of data flow direction and processing steps in a rendering pipeline is shown in FIG. 16, the input vertex data is located by using a vertex shader, and then primitive assembly is performed according to an element buffer object, which is generally triangle assembly. The assembled primitives are rasterized to become meshes, each mesh corresponds to one pixel fragment, then by using a fragment shader, each fragment is rendered with colors, inputted image textures are rendered with colors, and the image textures are processed by input parameters. The output of the fragment shader goes through test and blending operations, also known as the Alpha test and blending phase. The corresponding depth values of the fragments are detected at this stage, and they are used to determine whether the pixel is in front of or behind other objects and determine whether the pixel should be discarded. At this stage, the alpha value (which defines the transparency of an object) is detected (obtained), and the object is blended. Default settings are used at this stage, and finally rendering to the screen.

It should be noted that the shaders (Vertex Shader and Fragment Shader) in FIG. 15 are defined in the process of implementing the solution of the present disclosure, and the processing of the gray part is processed by OpenGL by default and cannot be changed by the user.

In the solution provided by the embodiment of the present disclosure, identification processing may be performed on video image frames of a video stream to obtain an initial image including a face; face adjustment processing is performed on the face region in the initial image to obtain an adjusted image; image quality enhancement processing is performed on the adjusted image to obtain an enhanced image; and rendering processing is performed on the enhanced image to obtain a target image. In this way, in this embodiment, quality of the target image can be improved through face adjustment processing and image quality enhancement processing, which is beneficial to improving user experience.

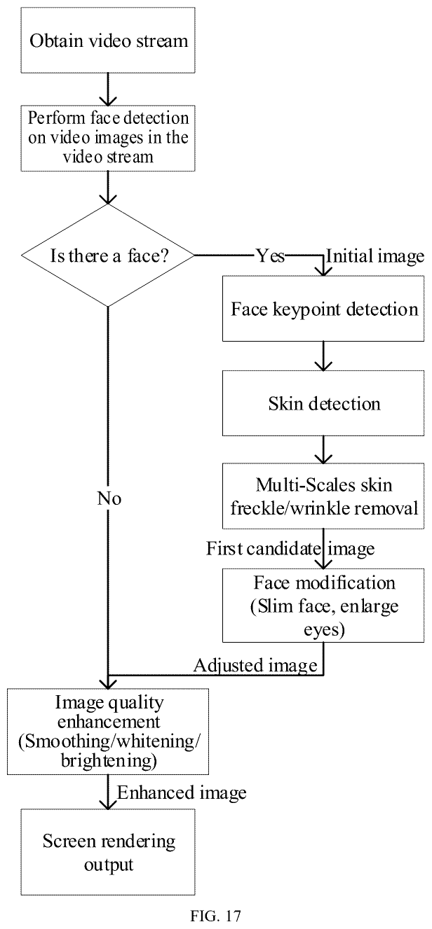

An image processing method provided by embodiments of the present disclosure is described below with reference to an embodiment, and referring to FIG. 17, the method includes:
after receiving the video stream, the electronic device performs face identification on video image frames of the video stream to obtain an initial image including a face, specifically referring to the content of step 11. Key point detection is performed on the initial image to obtain a key point vector, which is mapped to a preset skin template to obtain a mapping relationship, details refer to the example in FIG. 3. Then, abnormal regions, such as freckle regions and/or wrinkle regions, in the skin region is detected based on the mapping relationship, and the detected abnormal regions are cleared to obtain the first candidate image, which may be specifically referred to the method shown in FIG. 6 or the method shown in FIG. 8. Then, the electronic device may perform face modification on the first candidate image after clearing the abnormal regions, for example, face thinning processing or eye magnification processing, where the eye magnification processing may refer to the method shown in FIG. 9 and FIG. 10, and the face thinning processing may refer to the solutions shown in FIG. 11 and FIG. 12, to obtain an adjusted image. In addition, the electronic device may perform image quality enhancement processing on the adjusted image, where the image quality enhancement processing includes a skin smoothing processing, a whitening process, a brightening processing, or the like, to obtain an enhanced image. Finally, the electronic device may perform screen rendering on the enhanced image to obtain a target image, referring to the method shown in step 14, and display the target image.

After receiving the video stream, the electronic device performs face identification on video image frames of the video stream. When no face is detected, image quality enhancement processing is performed on the video image, referring to the method in step 13, an enhanced image is obtained. Finally, the electronic device may perform screen rendering on the enhanced image to obtain a target image, referring to the method shown in step 15, and display the target image.

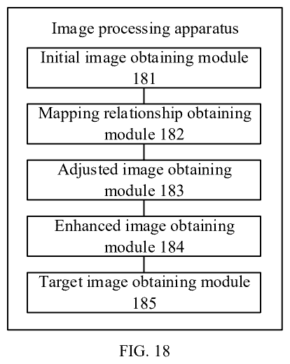

According to a second aspect of embodiments of the disclosure, there is provided an image processing apparatus, referring to FIG. 18, including:
an initial image obtaining module 181, configured to perform identification processing on video image frames of a video stream to obtain an initial image including a face;
a mapping relationship obtaining module 182, configured to perform alignment processing on a face region in the initial image with a preset skin template to obtain a mapping relationship between the face region and the preset skin template;
an adjusted image obtaining module 183, configured to adjust a skin region of the face region to obtain an adjusted image, where the skin region is determined based on the mapping relationship;
an enhanced image obtaining module 184, configured to perform image quality enhancement processing on the adjusted image to obtain an enhanced image; and
a target image obtaining module 185, configured to perform rendering processing on the enhanced image to obtain a target image.

In some embodiments, the mapping relationship obtaining module includes:
a first vector obtaining submodule, configured to obtain key point coordinates of a face in the preset skin template to obtain a first key point coordinate vector;
a second vector obtaining submodule, configured to obtain key point coordinates of the face in the initial image to obtain a second key point coordinate vector; and
a mapping relationship obtaining submodule, configured to input the first key point coordinate vector and the second key point coordinate vector into a preset distance model, obtain a solution of the preset distance model, and use the solution of the preset distance model as the mapping relationship.

In some embodiments, the mapping relationship obtaining submodule includes:
a first vector processing unit, configured to respectively obtain a coordinate mean value and a coordinate standard deviation of the first key point coordinate vector as a first coordinate mean value and a first coordinate standard deviation;
a second vector processing unit, configured to respectively obtain a coordinate mean value and a coordinate standard deviation of the second key point coordinate vector as a second coordinate mean value and a second coordinate standard deviation;
a first vector adjusting unit, configured to subtract the first coordinate mean value from the first key point coordinate vector and then divide by the first coordinate standard deviation to obtain a first adjusted coordinate vector;
a second vector adjusting unit, configured to subtract the second coordinate mean value from the second key point coordinate vector and then divide by the second coordinate standard deviation to obtain a second adjusted coordinate vector; and
a mapping relationship obtaining unit, configured to input the first adjusted coordinate vector and the second adjusted coordinate vector into the preset distance model, and perform singular value decomposition on the preset distance model to obtain the mapping relationship.

In some embodiments, the adjusted image obtaining module includes:
a processed image obtaining submodule, configured to perform, in response to sequentially scaling the initial image with different preset size ratios to candidate size images, clearing processing on one of the candidate size images to obtain a processed image; and
a first candidate image obtaining submodule, configured to restore, in response to a number of times of size adjustment being equal to a preset times threshold, a size of a final processed image to a size of the initial image to obtain a first candidate image, and use the first candidate image as the adjusted image.

In some embodiments, the processed image obtaining submodule includes:
a freckle region detection unit, configured to detect at least one freckle region of a skin region of the candidate size image, where the freckle region is a connected component with an area within a first preset area range, a size less than a first preset size threshold and larger than a second preset size threshold;
a first processed image obtaining unit, configured to perform clearing processing on the at least one freckle region to obtain a first processed image; and
a processed image obtaining unit, configured to restore, in response to a first cycle condition being satisfied, a size of the first processed image to a size of the initial image to obtain a final processed image;
where the first cycle condition is that a number of times of freckle region detection is equal to a first preset times threshold or a quantity of freckle regions currently detected is less than a first preset quantity threshold.

In some embodiments, the freckle region detection unit includes:
a target pixel obtaining subunit, configured to obtain target pixel data based on the mapping relationship and pixel data of each pixel of the preset skin template;
a second candidate image obtaining subunit, configured to replace pixel data at a corresponding position in the candidate size image with the target pixel data to obtain a second candidate image; and
a freckle region obtaining subunit, configured to perform connected component detection on the skin region of the second candidate image to obtain the freckle region of the skin region, where the freckle region of the skin region is a connected component with a freckle region size less than a first preset size threshold and larger than a second preset size threshold in the skin region.

In some embodiments, the freckle region obtaining subunit includes:
a binary image obtaining subunit, configured to convert a grayscale image of the candidate size image to binary images based on respective preset thresholds to obtain frames of binary images;
a first connected component obtaining subunit, configured to obtain connected regions in the frames of binary images to obtain connected components in the frames of binary images;
a second connected component obtaining subunit, configured to classify the connected components based on distances between center points of corresponding connected components in the frames of binary images to obtain a plurality of the connected components with distances between corresponding center points less than a preset distance threshold;
a freckle region obtaining subunit, configured to obtain positions and sizes of the plurality of connected components, and determine a connected component with a size less than the first preset size threshold and larger than the second preset size threshold of the plurality of connected components as the freckle region of the skin region, where each position of the plurality of connected components refers to a mean value of center point coordinates of corresponding connected components in respective frames of binary images, and each size of the plurality of connected components refers to a radius length of a circumscribed circle when an area of the connected component of the binary image is within a preset area range.

In some embodiments, after detecting the at least one freckle region of the skin region of the candidate size image, the processed image obtaining submodule further includes:
a wrinkle region determining unit, configured to determine, in response to detecting no freckle region, whether there is a wrinkle region, where the wrinkle region is a connected component with an area within a second preset area range, a size within a preset length range, and a width within a preset width range;
a wrinkle region clearing unit, configured to clear, in response to detecting at least one wrinkle region, a wrinkle region satisfying a second preset condition in the candidate size image to obtain a second processed image; and
a processed image obtaining unit, configured to restore, in response to a second cycle condition being satisfied, a size of a second processed image to a size of the initial image to obtain a final processed image;
where the second cycle condition is that a number of times of wrinkle region detection is equal to a second preset times threshold or a quantity of wrinkle regions currently detected is less than a second preset quantity threshold.

In some embodiments, the first processed image obtaining unit includes:
a freckle region obtaining subunit, configured to obtain at least one freckle region satisfying a preset condition; and
a first processed image obtaining subunit, configured to perform clearing processing on the at least one freckle region to obtain the first processed image.

In some embodiments, the freckle region obtaining subunit includes:
a freckle area obtaining subunit, configured to obtain an area of each freckle region in the skin region;
a candidate freckle obtaining subunit, configured to obtain a freckle region with an area within a first preset area range to obtain a candidate freckle region; and
a freckle region obtaining submodule, configured to obtain a candidate freckle region with roundness equal to a preset roundness value and convexity equal to a preset convexity value, and obtain at least one freckle region;
where the preset condition refers to that an area is within a preset area range, the roundness is equal to a preset roundness value, and the convexity is equal to a preset convexity value.

In some embodiments, the processed image obtaining submodule includes:
a wrinkle region detection unit, configured to detect a wrinkle region of the skin region of the candidate size image, where the wrinkle region is a connected component with an area within a second preset area range, a size within a preset length range, and a width within a preset width range;
a third processed image obtaining unit, configured to clear, in response to detecting at least one wrinkle region, a wrinkle region satisfying a second preset condition in the candidate size image to obtain a third processed image; and
a processed image obtaining unit, configured to restore, in response to a second cycle condition being satisfied, a size of the third processed image to the size of the initial image to obtain a final processed image;
where the second cycle condition is that a number of times of wrinkle region detection is equal to a second preset times threshold or a quantity of wrinkle regions currently detected is less than a second preset quantity threshold.

In some embodiments, the adjusted image obtaining module includes:
a mapping relationship obtaining submodule, configured to align the face region in the initial image with a preset skin template to obtain a mapping relationship between the face region and the preset skin template;
abnormal regions obtaining submodule, configured to obtain, in response to sequentially scaling the initial image to candidate size images with different preset sizes, an abnormal region of a skin region in the candidate size image to obtain an abnormal region feature map, where the abnormal region includes a freckle region, a wrinkle region or both, the freckle region is a connected component with an area within a first preset area range, a size less than a first preset size threshold and larger than a second preset size threshold, the wrinkle region is a connected component with an area within a second preset area range, a size within a preset length range, and a width within a preset width range, and the second preset area range is larger than the first preset area range; and
an adjusted image obtaining submodule, configured to clear, in response to the number of times of size adjustment being equal to the preset times threshold, the abnormal regions from a last candidate size image of the candidate size images to obtain the adjusted image.

In some embodiments, the adjusted image obtaining module further includes:
a second candidate image obtaining submodule, configured to perform scaling processing on an eye region in the first candidate image to obtain a second candidate image, and use the second candidate image as the adjusted image.

In some embodiments, the second candidate image obtaining submodule includes:
a scaling ratio obtaining unit, configured to obtain a scaling ratio of each pixel in the eye region of the first candidate image;
a target coordinate obtaining unit, configured to obtain target coordinate data of each pixel based on the scaling ratio and original coordinate data of each pixel; and
a second candidate image obtaining unit, configured to replace original coordinate data of each pixel in the first candidate image with target coordinate data to obtain the second candidate image.

In some embodiments, the scaling ratio obtaining subunit includes:
a distance ratio obtaining unit, configured to obtain a distance ratio of each pixel in the eye region of the first candidate image, where the distance ratio indicates that a distance ratio of a pixel closer to a center point of the eye region is smaller;
a scaling ratio obtaining subunit, configured to obtain a scaling ratio of each pixel based on the distance ratio, where the scaling ratio is proportional to the distance ratio.

In some embodiments, the distance ratio obtaining unit includes:
a length obtaining subunit, configured to obtain a major axis length and a minor axis length of the eye region;
a distance ratio obtaining subunit, configured to obtain the distance ratio of each pixel based on the long axis length, the short axis length, the coordinate data of the center point of the eye region, and the original coordinate data of each pixel.

In some embodiments, the scaling ratio obtaining subunit includes:
a scaling ratio obtaining submodule, configured to obtain the scaling ratio of each pixel based on the distance ratio and an initial value of the scaling ratio.

In some embodiments, the second candidate image obtaining submodule further includes:
a third candidate image obtaining unit, configured to perform size adjustment on the face region in the second candidate image to obtain a third candidate image, and use the third candidate image as the adjusted image.

In some embodiments, the third candidate image obtaining unit includes:
a distance value obtaining subunit, configured to obtain a distance value between the control point C1 of the face region and each pixel in the face region;
a deformation ratio obtaining subunit, configured to obtain a deformation ratio of each pixel based on the distance value, where the deformation ratio is configured to indicate that a moving distance of a pixel farther away from the control point C1 is smaller;
a target pixel obtaining subunit, configured to calculate target pixel data of each pixel based on the coordinate data of the target position M of the control point C1, the coordinate data of the control point C1, and the coordinate data of the target position X of each pixel;
a third candidate image obtaining subunit, configured to replace pixels of the face region of the second candidate image with the target pixel data to obtain the third candidate image.

In some embodiments, the image quality enhancement processing includes skin smoothing processing, whitening processing, brightening processing or any combination thereof, and the enhanced image obtaining module includes:
a first feature map obtaining submodule, configured to perform skin smoothing processing on the adjusted image to obtain a first skin smoothed feature map;
a second feature map obtaining submodule, configured to adjust a skin smoothing degree of the first skin smoothed feature map to obtain a second skin smoothed feature map;
a skin tone brightened feature map obtaining submodule, configured to perform skin tone brightening processing on the second skin smoothed feature map to obtain a skin tone brightened feature map;
a soft light feature map obtaining submodule, configured to perform soft light processing based on the skin tone brightened feature map and the adjusted image to obtain a soft light feature map; and
an enhanced image obtaining submodule, configured to obtain the enhanced image based on the adjusted image, the second skin smoothed feature map, the skin tone brightened feature map, the soft light feature map and respective weight values.

In some embodiments, the first feature map obtaining submodule includes:
a filtered sub-image obtaining unit, configured to filter a green sub-image of the adjusted image to obtain a filtered sub-image;
a difference sub-image obtaining unit, configured to obtain a pixel data difference of a same pixel in the adjusted image and the filtered sub-image to obtain a difference sub-image;
a compensation sub-image obtaining unit, configured to compensate pixel data of each pixel in the difference sub-image based on preset compensation data to obtain the difference compensation sub-image; and
a first feature map obtaining unit, configured to perform light compensation on the difference compensation sub-image to obtain the first skin smoothed feature map.

In some embodiments, a filtering method used for filtering the green sub-image of the adjusted image includes: averaging filtering, Gaussian filtering, bilateral filtering, guiding filtering, or any combination thereof.

In some embodiments, a filtering kernel of the Gaussian filtering is a circular filtering kernel, and a sum of weight values of the circular filtering kernel is equal to a preset weight value.

In some embodiments, the first feature map obtaining unit includes:
a pixel data comparison subunit, configured to compare pixel data of each pixel of the difference compensation sub-image with preset compensation data;
a target pixel data obtaining subunit, configured to obtain, in response to that the pixel data of each pixel is greater than or equal to the preset compensation data, target pixel data corresponding to the pixel data based on a first light compensation model;
the target pixel data obtaining subunit, further configured to obtain, in response to that the pixel data of each pixel is less than the preset compensation data, target pixel data corresponding to the pixel data based on a second light compensation model.
a pixel data replacing subunit, configured to replace pixel data of each pixel of the difference compensation sub-image with the target pixel data; and
a first feature map obtaining subunit, configured to determine, in response to that the number of times of compensation reaches a preset compensation times threshold, a difference compensation sub-image obtained by a last compensation as the first skin smoothed feature map.

In some embodiments, a value range of the preset compensation times threshold is [1, 10].

In some embodiments, the second feature map obtaining submodule includes:
a grayscale image obtaining unit, configured to obtain a grayscale image corresponding to the adjusted image;
a brightened image obtaining unit, configured to brighten grayscale data of each pixel in the grayscale image based on preset skin smoothing degree data to obtain a grayscale brightened image; and
a second feature map obtaining unit, configured to adjust pixel data of each pixel of the adjusted image based on the first skin smoothed feature map and the grayscale brightened image to obtain the second skin smoothed feature map.

In some embodiments, after identifying the video image frames of the video stream, the enhanced image obtaining module is further configured to in response to the face region not being detected in the video image frames, perform image quality enhancement processing on the video image frames to obtain an enhanced image; and

the target image obtaining module is further configured to perform rendering processing on the enhanced image to obtain a target image.

It should be noted that the apparatus embodiment shown in this embodiment matches the content of the above-mentioned method embodiment, reference may be made to the content of the above-mentioned method embodiment, and details are not described herein again.

In exemplary embodiments, there is provided an electric device, including a display screen;
a processor, and
a memory for storing computer programs executable by the processor;
where the processor is configured to execute a computer program in the memory to implement the above-mentioned method.

In exemplary embodiments, there is provided a server, including:
a processor, and
a memory for storing computer programs executable by the processor;
where the processor is configured to execute a computer program in the memory to implement the above-mentioned method.

In an exemplary embodiment, there is further provided a video conference system, including a plurality of electronic devices and a plurality of servers; each of the plurality of servers includes:
a processor, and
a memory for storing computer programs executable by the processor;
where the processor is configured to execute a computer program in the memory to implement the above-mentioned method.

In the exemplary embodiments, there is further provided a non-transitory computer-readable storage medium, such as a memory including executable computer programs that can be executed by a processor to implement the method as described in the above embodiment. The readable storage medium may be a ROM, a random access memory (RAM), a CD-ROM, a magnetic tape, a floppy disk, an optical data storage device, or the like.

Those skilled in the art will readily conceive other embodiments of the present disclosure upon consideration of the specification and practice of the embodiments disclosed herein. This disclosure aims to cover any variations, uses, or adaptive changes that follow the general principles of the disclosure and include common knowledge or customary technical means in the field of technology that are not disclosed in this disclosure. The specification and embodiments are considered as examples only, true scope and spirit of the disclosure is indicated by the following claims.

It is to be understood that the present disclosure is not limited to the precise structures described above and shown in the drawings, and various changes and modifications may be made without departing from the scope thereof. The scope of the present disclosure is limited only by the appended claims.

1. An image processing method, comprising:
identifying video image frames of a video stream to obtain an initial image comprising a face;
aligning a face region in the initial image with a preset skin template to obtain a mapping relationship between the face region and the preset skin template;
adjusting a skin region of the face region to obtain an adjusted image, wherein the skin region is determined based on the mapping relationship;
performing image quality enhancement processing on the adjusted image to obtain an enhanced image; and
rendering the enhanced image to obtain a target image.

2. The method according to claim 1, wherein aligning the face region comprises:
obtaining key point coordinates of a face in the preset skin template to obtain a first key point coordinate vector;
obtaining key point coordinates of the face in the initial image to obtain a second key point coordinate vector; and
inputting the first key point coordinate vector and the second key point coordinate vector into a preset distance model to obtain a solution of the preset distance model, and determining the solution of the preset distance model as the mapping relationship.

3. The method according to claim 2, wherein obtaining the solution of the preset distance model comprises:
respectively obtaining a coordinate mean value and a coordinate standard deviation of the first key point coordinate vector as a first coordinate mean value and a first coordinate standard deviation;
respectively obtaining a coordinate mean value and a coordinate standard deviation of the second key point coordinate vector as a second coordinate mean value and a second coordinate standard deviation;
subtracting the first coordinate mean value from the first key point coordinate vector and then dividing by the first coordinate standard deviation to obtain a first adjusted coordinate vector;
subtracting the second coordinate mean value from the second key point coordinate vector and then dividing by the second coordinate standard deviation to obtain a second adjusted coordinate vector; and
inputting the first adjusted coordinate vector and the second adjusted coordinate vector into the preset distance model, and performing singular value decomposition on the preset distance model to obtain the mapping relationship.

4. The method according to claim 1, wherein adjusting the skin region of the face region comprises:
sequentially scaling the initial image with different preset size ratios to obtain candidate size images, performing clearing processing on one of the candidate size images to obtain a processed image; and
in response to a number of times of size adjustment being equal to a preset times threshold, performing clearing processing on a last candidate size image of the candidate size images to obtain a last processed image, restoring a size of the last processed image to a size of the initial image to obtain a first candidate image, and determining the first candidate image as the adjusted image.

5. The method according to claim 4, wherein performing clearing processing on the candidate size image comprises:
detecting at least one freckle region of a skin region of the candidate size image, wherein the freckle region is a connected component with an area within a first preset area range, a size less than a first preset size threshold and larger than a second preset size threshold;
performing clearing processing on the at least one freckle region to obtain a first processed image; and
in response to a first cycle condition being satisfied, restoring a size of the first processed image to a size of the initial image to obtain a final processed image;
wherein the first cycle condition is that a number of times of freckle region detection is equal to a first preset times threshold or a quantity of freckle regions currently detected is less than a first preset quantity threshold.

6. The method according to claim 5, wherein detecting the at least one freckle region of the skin region of the candidate size image comprises:
obtaining target pixel data based on the mapping relationship and pixel data of each pixel of the preset skin template;
replacing pixel data of corresponding positions in the candidate size image with the target pixel data to obtain a second candidate image; and
performing connected component detection on the skin region of the second candidate image to obtain the freckle region of the skin region, wherein the freckle region of the skin region is a connected component with a freckle region size less than a first preset size threshold and larger than a second preset size threshold in the skin region.

7. The method according to claim 6, wherein performing connected component detection on the skin region of the second candidate image comprises:
converting a grayscale image of the candidate size image to binary images based on respective preset thresholds to obtain frames of binary images;
respectively obtaining connected regions in the frames of binary images to obtain connected components in the frames of binary images;
classifying the connected components based on distances between center points of corresponding connected components in the frames of binary images, to obtain a plurality of connected components with distances between corresponding center points less than a preset distance threshold;
obtaining positions and sizes of the plurality of connected components; and
determining a connected component with a size less than the first preset size threshold and larger than the second preset size threshold of the plurality of connected components as the freckle region of the skin region.

8. The method according to claim 5, wherein after detecting the at least one freckle region of the skin region of the candidate size image, the method further comprises:
in response to detecting no freckle region, determining whether there is a wrinkle region, wherein the wrinkle region is a connected component having an area within a second preset area range, a size within a preset length range and a width within a preset width range;
in response to detecting at least one wrinkle region, performing clearing processing on a wrinkle region satisfying a second preset condition in the candidate size image to obtain a second processed image; and
in response to a second cycle condition being satisfied, restoring a size of the second processed image to the size of the initial image to obtain a final processed image;
wherein the second cycle condition is that a number of times of wrinkle region detection is equal to a second preset times threshold or a quantity of wrinkle regions currently detected is less than a second preset quantity threshold.

9. The method according to claim 4, wherein performing clearing processing on the candidate size image comprises:
detecting a wrinkle region of the skin region of the candidate size image, wherein the wrinkle region is a connected component having an area within a second preset area range, a size within a preset length range, and a width within a preset width range;
in response to detecting at least one wrinkle region, performing clearing processing on a wrinkle region satisfying a second preset condition in the candidate size image to obtain a third processed image; and
in response to a second cycle condition being satisfied, restoring a size of the third processed image to the size of the initial image to obtain the processed image;
wherein the second cycle condition is that a number of times of wrinkle region detection is equal to a second preset times threshold or a quantity of wrinkle regions currently detected is less than a second preset quantity threshold.

10. The method according to claim 1, wherein adjusting the skin region of the face region comprises:
sequentially scaling the initial image to candidate size images with different preset sizes, obtaining an abnormal region of the skin region in the candidate size image, wherein the abnormal region comprises a freckle region, a wrinkle region or both, the freckle region is a connected component with an area within a first preset area range, a size less than a first preset size threshold and larger than a second preset size threshold, the wrinkle region is a connected component with an area within a second preset area range, a size within a preset length range, and a width within a preset width range, and the second preset area range is larger than the first preset area range; and
in response to a number of times of size adjustment being equal to a preset times threshold, clearing the abnormal region from a last candidate size image of the candidate size images to obtain the adjusted image.

11. The method according to claim 4, wherein after obtaining the first candidate image, the method further comprises:
scaling an eye region in the first candidate image to obtain a second candidate image, and determining the second candidate image as the adjusted image.

12. The method according to claim 11, wherein scaling the eye region in the first candidate image comprises:
obtaining a scaling ratio of each pixel in the eye region of the first candidate image;
obtaining target coordinate data of each pixel based on the scaling ratio and original coordinate data of each pixel; and
replacing original coordinate data of each pixel in the first candidate image with target coordinate data to obtain the second candidate image;
wherein obtaining the scaling ratio of each pixel in the eye region of the first candidate image comprises:
obtaining a distance ratio of each pixel in the eye region of the first candidate image, wherein the distance ratio indicates that a moving distance ratio of a pixel closer to a center point of the eye region is smaller; and
obtaining the scaling ratio of each pixel based on the distance ratio, wherein the scaling ratio is proportional to the distance ratio;
wherein obtaining the distance ratio of each pixel in the eye region of the first candidate image comprises:
obtaining a long axis length and a short axis length of the eye region; and
obtaining the distance ratio of each pixel based on the long axis length, the short axis length, coordinate data of the center point of the eye region, and original coordinate data of each pixel;
wherein obtaining the scaling ratio of each pixel based on the distance ratio comprises:
obtaining the scaling ratio of each pixel based on the distance ratio and an initial value of the scaling ratio.

13.-15. (canceled)

16. The method according to claim 11, wherein after obtaining the second candidate image, the method further comprises:
performing size adjustment on a face region in the second candidate image to obtain a third candidate image, and
determining the third candidate image as the adjusted image.

17. The method according to claim 16, wherein performing size adjustment on the face region in the second candidate image comprises:
obtaining a distance value between a control point of the face region and each pixel in the face region;
obtaining a deformation ratio of each pixel based on the distance value, wherein the deformation ratio is configured to indicate that a moving distance of a pixel farther away from the control point is smaller;
calculating target pixel data of each pixel based on coordinate data of a target position of the control point, coordinate data of the control point, and coordinate data of a target position X of each pixel; and
replacing pixels of the face region of the second candidate image with the target pixel data to obtain the third candidate image.

18. The method according to claim 1, wherein the image quality enhancement processing comprises skin smoothing processing, whitening processing, brightening processing or any combination thereof, and performing image quality enhancement processing on the adjusted image comprises:
performing skin smoothing processing on the adjusted image to obtain a first skin smoothed feature map;
adjusting a smoothing degree of the first skin smoothed feature map to obtain a second skin smoothed feature map;
performing skin tone brightening processing on the second skin smoothed feature map to obtain a skin tone brightened feature map;
performing soft light processing based on the skin tone brightened feature map and the adjusted image to obtain a soft light feature map; and
obtaining the enhanced image based on the adjusted image, the second skin smoothed feature map, the skin tone brightened feature map, the soft light feature map and respective weight values.

19. The method according to claim 18, wherein performing smoothing processing on the adjusted image comprises:
performing filtering processing on a green sub-image of the adjusted image to obtain a filtered sub-image;
obtaining a pixel data difference value of a same pixel in the adjusted image and the filtered sub-image to obtain a difference sub-image;
compensating pixel data of each pixel in the difference sub-image based on preset compensation data to obtain a difference compensation sub-image; and
performing light compensation on the difference compensation sub-image to obtain the first skin smoothed feature map;
wherein adjusting the smoothing degree of the skin smoothed feature map to obtain the second skin smoothed feature map comprises:
obtaining a grayscale image corresponding to the adjusted image;
performing brightening processing on grayscale data of each pixel in the grayscale image based on preset skin smoothing degree data to obtain a grayscale brightened image; and
adjusting pixel data of each pixel of the adjusted image based on the first skin smoothed feature map and the grayscale brightened image to obtain the second skin smoothed feature map.

20. The method according to claim 19, wherein performing filtering processing on the green sub-image of the adjusted image comprises: averaging filtering, Gaussian filtering, bilateral filtering, guiding filtering, or any combination thereof;
wherein a filtering kernel of the Gaussian filtering is a circular filtering kernel, and a sum of weight values of the circular filtering kernel is equal to a preset weight value.

21. (canceled)

22. The method according to claim 19, wherein performing light compensation on the difference compensation sub-image comprises:
comparing pixel data of each pixel of the difference compensation sub-image with preset compensation data;
in response to that the pixel data of each pixel is greater than or equal to the preset compensation data, obtaining target pixel data corresponding to the pixel data based on a first light compensation model;
in response to that the pixel data of each pixel is less than the preset compensation data, obtaining target pixel data corresponding to the pixel data based on a second light compensation model;
replacing pixel data of each pixel of the difference compensation sub-image with the target pixel data; and
in response to a number of times of compensation reaching a preset compensation times threshold, determining that a difference compensation sub-image obtained by a last compensation is the first skin smoothed feature map;
wherein a value range of the preset compensation times threshold is [1, 10].

23.-24. (canceled)

25. The method according to claim 1, wherein after identifying the video image frames of the video stream, the method further comprises:
in response to no face region being detected in the video image frames, performing image quality enhancement processing on the video image frames to obtain the enhanced image; and
rendering the enhanced image to obtain the target image.

26.-51. (canceled)

52. A non-transitory computer-readable storage medium, when an executable computer program in the computer-readable storage medium is executed by a processor, causing the processor to implement operations comprising:
identifying video image frames of a video stream to obtain an initial image comprising a face;
aligning a face region in the initial image with a preset skin template to obtain a mapping relationship between the face region and the preset skin template;
adjusting a skin region of the face region to obtain an adjusted image, wherein the skin region is determined based on the mapping relationship;
performing image quality enhancement processing on the adjusted image to obtain an enhanced image; and
rendering the enhanced image to obtain a target image.
